(19) United States
(12) Patent Application Publication
(10) Pub. No.: US 2025/0240711 A1
(43) Pub. Date: Jul. 24, 2025

(54) AI-BASED NETWORK MIXED-SERVICE DETECTION FOR UE POWER SAVING

(71) Applicant: Samsung Electronics Co., Ltd., Suwon-si (KR)

(72) Inventors: Yuqiang Heng, Plano, TX (US); Vutha Va, Plano, TX (US); Priyabrata Parida, Dallas, TX (US); Anum Ali, Frisco, TX (US); Khuong N. Nguyen, Frisco, TX (US); Boon Loong Ng, Plano, TX (US)

(21) Appl. No.: 19/019,214

(22) Filed: Jan. 13, 2025

Related U.S. Application Data
(60) Provisional application No. 63/624,144, filed on Jan. 23, 2024.

(51) Int. Cl. H04W 52/02; H04W 28/02

(52) U.S. Cl. CPC H04W 52/0209; H04W 28/0268

(57) ABSTRACT

Methods and apparatuses for artificial intelligence (AI)-based network mixed-service detection for user equipment (UE) power saving. A method performed by a UE includes identifying a characteristic of packets of traffic at a UE and generating a set of streams corresponding to a set of different characteristics, including generating a respective stream corresponding each identified characteristic that is different from another identified characteristic. The method further includes classifying the set of streams into a set of traffic classes, respectively, based on features extracted from the set of streams every sampling window and selecting, from a set of UE assistance information (UAI) parameters that impact UE power consumption and quality of service (QOS), at least one UAI parameter to reduce power consumption of the UE while maintaining a QoS level. The method includes transmitting, via UAI to a gNB, a UE-preference including the at least one selected UAI parameter.

### CROSS-REFERENCE TO RELATED APPLICATION(S) AND CLAIM OF PRIORITY

This application claims priority under 35 U.S.C. § 119 (e) to U.S. Provisional Patent Application No. 63/624,144 filed on Jan. 23, 2024. The above-identified provisional patent application is hereby incorporated by reference in its entirety.

### TECHNICAL FIELD

This disclosure relates generally wireless communication systems. More specifically, this disclosure relates to artificial intelligence (AI)-based network mixed-service detection for user equipment (UE) power saving.

### BACKGROUND

5G wireless communication systems are implemented to include higher frequency (mmWave) bands, such as 28 GHz or 60 GHz bands or, in general, above 6 GHz bands, so as to accomplish higher data rates, or in lower frequency bands, such as below 6 GHz, to enable robust coverage and mobility support. A communication system includes a DownLink (DL) that conveys signals from transmission points such as Base Stations (BSs), eNodeBs, gNodeBs or TRPs to User Equipments (UEs). The communication system also includes an UpLink (UL) that conveys signals from UEs to reception points such as eNodeBs. A UE, also commonly referred to as a terminal or a mobile station, may be fixed or mobile and may be a cellular phone, a personal computer device, etc. An eNodeB, which is generally a fixed station, may also be referred to as an access point or other equivalent terminology.

Modern network traffic is managed under the Internet protocol suite. The Transmission Control Protocol (TCP), User Datagram Protocol (UDP) and the Internet Protocol (IP) provides the foundation of how network data is packetized, addressed and routed between the sender and the receiver devices, and is responsible for establishing and maintaining a reliable connection.

### SUMMARY

This disclosure provides AI-based network mixed-service detection for UE power saving.

In one embodiment, a method for AI-based network mixed-service detection for UE power saving is provided. The method includes identifying a characteristic of packets of traffic at the UE. The method includes generating a set of streams corresponding to a set of different characteristics. Generating the set of streams comprises generating a respective stream corresponding each identified characteristic that is different from another identified characteristic. Each respective stream includes a subset of the packets that share the identified characteristic that corresponds to the respective stream. The method includes classifying the set of streams into a set of traffic classes, respectively, based on features extracted from the set of streams every sampling window. The method includes selecting, from a set of UE assistance information (UAI) parameters that impact UE power consumption and quality of service (QOS), at least one UAI parameter to reduce power consumption of the UE while maintaining a QoS level based on the set of traffic classes. The method includes transmitting, via UAI to a gNB, a request for a UE-preferred configuration that includes the at least one selected UAI parameter.

In another embodiment, a user equipment (UE) for for AI-based network mixed-service detection for UE power saving is provided. The UE includes a processor configured to identify a characteristic of packets of traffic at the UE. The processor is configured to generate a set of streams corresponding to a set of different characteristics. To generate the set of streams, the processor is configured to generate a respective stream corresponding each identified characteristic that is different from another identified characteristic. Each respective stream includes a subset of the packets that share the identified characteristic that corresponds to the respective stream. The processor is configured to classify the set of streams into a set of traffic classes, respectively, based on features extracted from the set of streams every sampling window. The processor is configured to select, from a set of UE assistance information (UAI) parameters that impact UE power consumption and quality of service (QOS), at least one UAI parameter to reduce power consumption of the UE while maintaining a QoS level based on the set of traffic classes. The processor is configured to transmit, via UAI to a gNB, a request for a UE-preferred configuration that includes the at least one selected UAI parameter.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases may be provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to this disclosure;

FIG. 2 illustrates an example gNodeB (gNB) according to this disclosure;

FIG. 3 illustrates an example user equipment (UE) according to this disclosure;

FIG. 4 illustrates a method for a UE to detect active services and select 5G configurations to reduce power consumption while ensuring QoS, according to embodiments of this disclosure;

FIG. 5 illustrates a first example processing pipeline for UE service detection, in accordance with an embodiment of this disclosure;

FIG. 6 illustrates an example method of packet segregation into bidirectional flows based on the TCP/IP five-tuple socket and the ML prediction for active streams, according to embodiments of this disclosure;

FIG. 7 illustrates a multi-sample sliding window that includes a plural number of sampling windows, in accordance with an embodiment of this disclosure;

FIG. 8 illustrates an example transition between the active state and inactive state of a stream, in accordance with an embodiment of this disclosure;

FIG. 9 illustrates an example method for stream-level service prediction, in accordance with an embodiment of this disclosure;

FIG. 10 illustrates an example method for detecting a service change based on an audio/video call stream, in accordance with an embodiment of this disclosure;

FIG. 11 illustrates an example method of temporal filtering of per-stream predictions, in accordance with an embodiment of this disclosure;

FIG. 12 illustrates an example method of combining per-flow predictions to obtain the per-PID prediction, in accordance with an embodiment of this disclosure;

FIG. 13 illustrates an example method of temporal filtering of per-PID predictions, in accordance with an embodiment of this disclosure;

FIG. 14 illustrates an example method of selecting a UE-preferred configuration for mixed-service, in accordance with an embodiment of this disclosure;

FIG. 15 illustrates a method of stream-level service prediction with one-shot ML classification that includes a second example processing pipeline for UE service detection, in accordance with an embodiment of this disclosure;

FIG. 16 illustrates an architecture of an ML classification model that includes a multi-modality fusion model, in accordance with an embodiment of this disclosure;

FIG. 17 illustrates another example processing pipeline for UE service detection that includes a post-processing pipeline for one-shot stream-level predictions, in accordance with an embodiment of this disclosure;

FIG. 18 illustrates a third example processing pipeline for UE service detection based on a PID-aggregated service detection design, in accordance with an embodiment of this disclosure; and

FIG. 19 illustrates a method for AI-based network mixed-service detection for UE power saving, in accordance with an embodiment of this disclosure.

### DETAILED DESCRIPTION

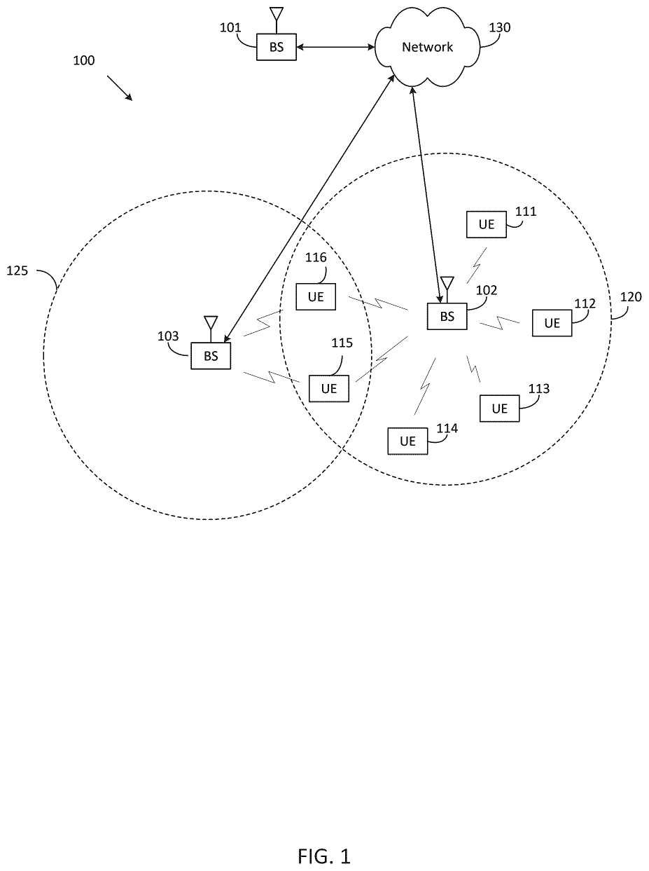

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged wireless communication system or device.

Aspects of the present disclosure may be applied to 5th generation (5G) communication systems, 6G or even later releases which may use THz bands. The 5G cellular communication systems deliver high data rate and low latency to support a wide range of the applications, mainly achieved through larger bandwidths and more antennas. On the other hand, the increase in power consumption is particularly challenging for user equipments (UEs) that rely on battery power. In an effort to overcome this challenge, Release 16 of 3GPP specifications provides the UE assistance information (UAI) framework where a UE can inform the base station (BS) about its preferred parameters. A UE can leverage local information and request configurations that can both achieve satisfactory quality of service (QOS) while reducing power consumption if possible. The successful detection and identification of different network services is a enables QoS-aware power saving solutions. The UE may monitor its traffic data as part of a process to determine the set of services currently being consumed. Modern network traffic is typically encrypted and is generated by a mix of services, making accurate detection of the underlying services challenging. This disclosure provides systems and methods for the detection of application services at the UE and service-specific configuration selection for power saving.

This disclosure provides solutions to detect and identify the services currently being consumed at the UE, and uses such information for UE power saving via configuration selection. The UE monitors its ingress and egress IP packets, segregates the traffic into streams, classifies the service type based on the traffic streams, and performs a host of post-processing techniques to deliver accurate detection of the set of ongoing services. Depending on the services being consumed, the UE selects and requests a suitable configuration to reduce power consumption while ensuring QoS via the UAI framework.

This disclosure provides multiple technical solutions, such as separation of traffic packets into streams to facilitate more accurate classification of the underlying service per stream. Another technical solution includes post-processing techniques that combine the classification results over-time and across streams to deliver consistent and accurate detection of network services. Techniques to reduce the operation complexity of the traffic detection algorithm are other technical solutions provided in this disclosure. As another technical solution, this disclosure provides a mechanism to select service-specific configurations to save power while ensuring QoS.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

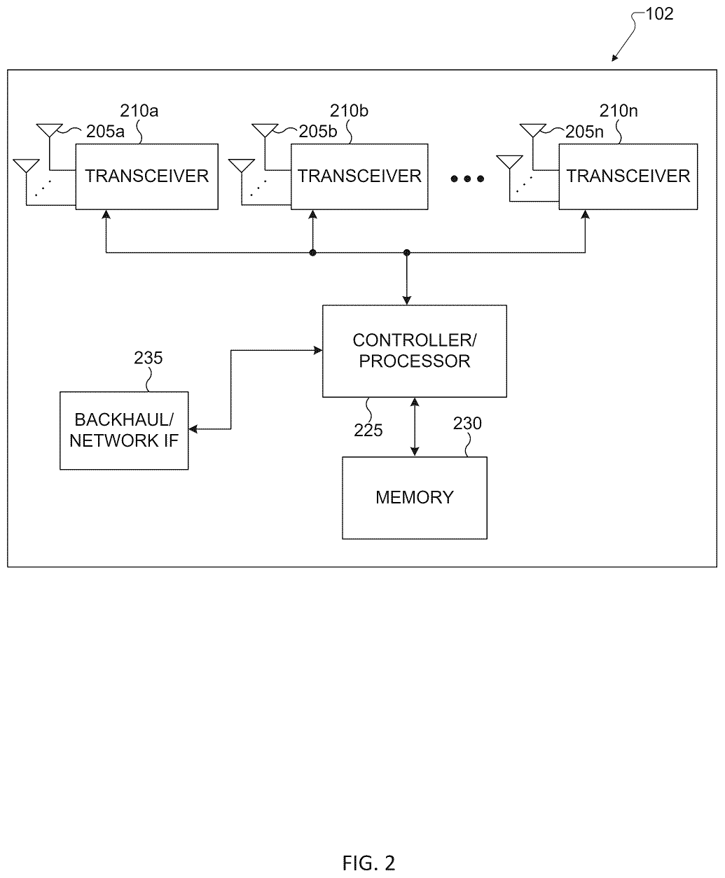

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

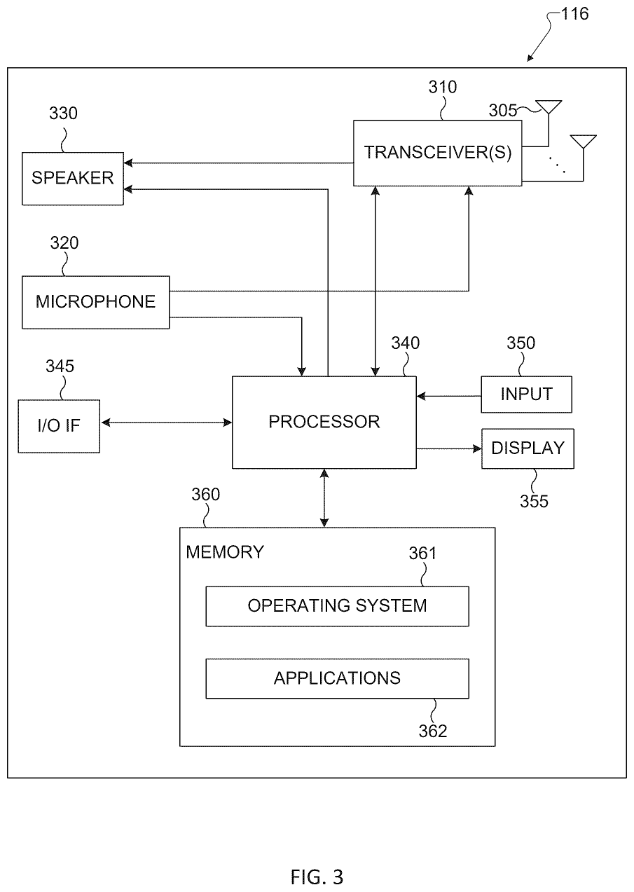

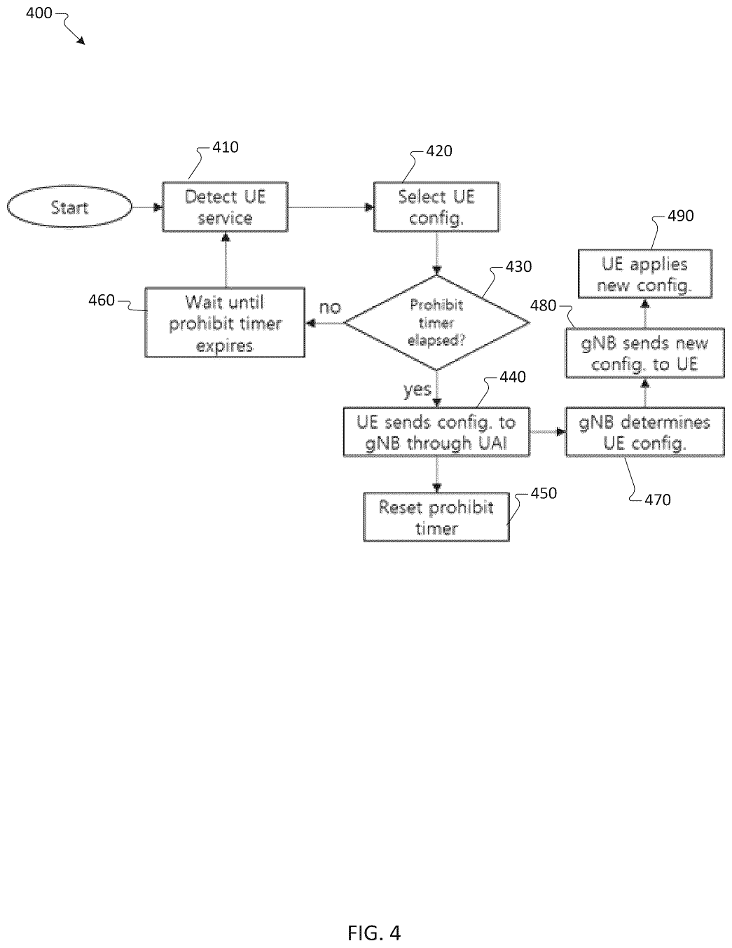

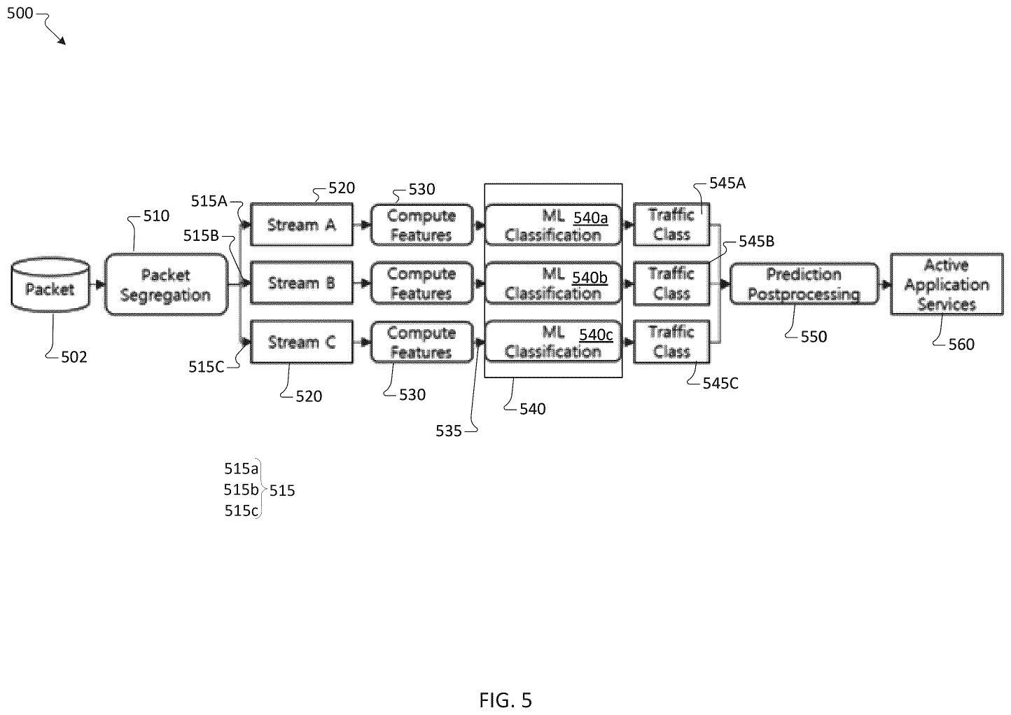

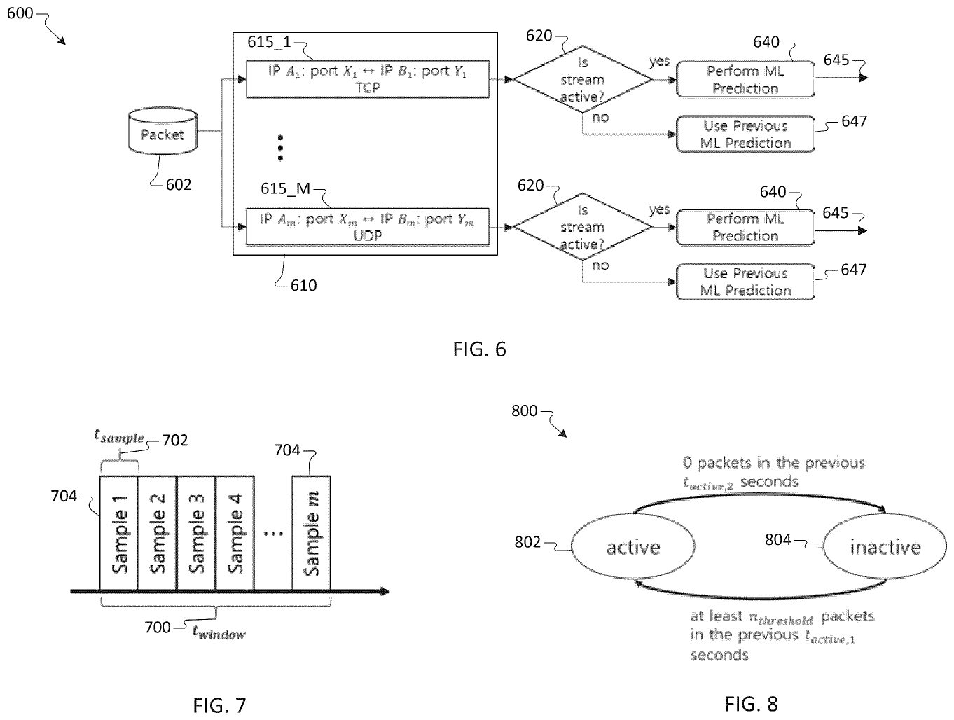

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

FIG. 4 illustrates a method 400 for a UE to detect active services and select 5G configurations to reduce power consumption while ensuring QoS, according to embodiments of this disclosure. The embodiment of the method 400 shown in FIG. 4 is for illustration only, and other embodiments could be used without departing from the scope of this disclosure. The method 400 is implemented by the UE 116 and the gNB 102 of FIG. 1. Particularly, blocks 410-160 are performed by the UE 116, and blocks 470-490 are performed by the gNB 102.

At block 410, the UE 116 detects active services generating packets of network traffic on the device. The active services currently generating network traffic on the UE can be different application service types. Detecting that active services currently generating network traffic on the UE can include determining which application service types are originating packet of network traffic.

Table 1 shows that the UE 116 can store a set of different application service types that includes: video streaming, social media browsing, file downloading, cloud gaming, live video streaming, video calling, web browsing (such as light web browsing), audio calling, internet speed testing, and communicating background traffic. The set of different application service types can include more, less, or other application service types. One or more application service types can be grouped into an application service group. Within each application service group, the one or more application service types share a throughput requirement and a latency requirement. As shown in Table 1, a set of traffic classes is mapped to a set of application service groups, respectively. Within Table 1, Column 1 is denoted as C, which is the set of traffic classes (for example, the set of all traffic classes). Each row includes a different traffic class. Within the set C, each respective traffic class is indexed by or denoted as c. Column 2 shows set of application service groups, and each row includes a different application service group. Table 1 includes an example definition of traffic classes and applications services mapped to each class. In this disclosure, the term “traffic class” is used interchangeably with “service class.”

The categorization of application services into traffic classes is use-case specific. For the purpose of QoS-aware UE parameter selection for power saving, the factors affecting a user's perception of QoS include the throughput and latency experienced by the user while using different applications on the UE 116. The service types could be categorized based on the throughput and latency requirements of each application. An example categorization is provided in Table. 1. Services in the same traffic class will likely share similar optimal UE configurations.

TABLE 1
Example Definition of traffic classes and
applications services mapped to each class

| Traffic class | Application Service Group |
|---|---|
| High throughput, high latency (HT-HL) | Video streaming, social media |
| | browsing, file download |
| High throughput, low latency (HT-LL) | Cloud gaming, live video |
| | streaming, video call |
| Low throughput, high latency (LT-HL) | Light web browsing |
| Low throughput, low latency (LT-LL) | Audio call |
| Very high throughput, low latency | Internet speed test |
| (VHT-LL) | |
| Very low throughput, high latency | Background traffic |
| (VLT-HL) | |

At block 420, the UE 116 selects a suitable configuration that reduces (for example, minimizes) the power consumption of the UE while achieving the required QoS of the active services. More particularly, from a set of UAI parameters that impact UE power consumption and QoS, the UE 116 selects at least one UAI parameter to reduce power consumption of the UE while maintaining a QoS level based on the detected active services.

The QoS is application-specific. For instance, in International Telecommunication Union (ITU) Recommendation p.1203, the mean opinion score (MOS) quantifies the QoS for video and audio users by considering the frame rate, encoding rate and stalling behavior during video and audio streaming. The latency is another proxy for quantifying QoS. In 3GPP TS 23.501, the packet delay budget (PDB) specifies the 98th percentile latency of all TCP/IP packets required to achieve satisfactory QoS for different applications.

Through the UAI framework specified in 3GPP Standard Release 16 (3GPP TS 38.331 V16.5.0), the UE 116 can report one or more of the following configurations that will impact both the UE's power consumption and QoS. As an example, the set of UAI parameters that impact UE power consumption and QoS includes: preferred DRX configuration; preferred maximum aggregated bandwidth; preferred maximum number of component carriers (CC); preferred maximum number of multiple-input multiple-output (MIMO) layers; and preferred minimum scheduling offset for cross-slot scheduling.

A prohibit timer prevents too-frequent reconfigurations. The prohibit timer resets when the UE 116 sends a request for a new configuration to the gNB 102 via UAI, and the prohibit timer elapses after a specified period of time. At block 430, the UE 116 determines whether a prohibit timer elapsed. If the prohibit timer from the previous configuration request has elapsed, then at block 440, the UE sends the new UE-selected configuration to the gNB through UAI and resets the prohibit timer at block 450. If the prohibit timer has not elapsed, then at block 460, the UE waits until the prohibit timer expires, and then restarts the method 400 (for example, returning block 410).

At block 470, the gNB 102 receives the UAI transmitted from the UE, and determines a UE configuration based on the received UAI. For example, the gNB determines to accept, reject, or modify the UE-selected configuration that the UE requested. If the gNB accepts the requested configuration, then the gNB 102 selects the requested configuration as a new configuration to be transmitted to the UE. If the gNB modifies the requested configuration, then the gNB 102 selects a modified configuration as the new configuration. The modified configuration is different from both the requested configuration and the current configuration. If the gNB 102 rejects the request and thereby decides to keep the current configuration, no further action is needed, and the method 400 ends.

At block 480, the gNB 102 sends a new configuration to the UE, which applies the new configuration at block 490. The UE resets the prohibit timer in response to applying the new configuration received from the gNB.

The method 400 can be a mechanism that can be always running on the UE. Alternatively, the mechanism can be activated when the UE determines to reduce its power consumption, such as when the power saving mode is turned on, the remaining battery level is low, or the UE is not connected to a charger, etc.

FIG. 5 illustrates an example processing pipeline 500 for UE service detection, in accordance with an embodiment of this disclosure. The embodiment of the processing pipeline 500 shown in FIG. 5 is for illustration only, and other embodiments could be used without departing from the scope of this disclosure. The procedure of block 410 of FIG. 4 can include or can be the same as the processing pipeline 500 of FIG. 5, which represents a method for the UE 116 to detect active services generating packets of network traffic on the UE.

Network traffic at the UE includes packets of traffic that ingress and egress at the UE, which includes both uplink packets to be transmitted and downlink packets received from an external communication device. Each respective packet 502 among the packets of traffic is processed through the processing pipeline 500. In some use cases, background traffic at the UE arrives continuously.

The processing pipeline 500 includes a packet segregation module 510, a pre-processing filter 520, a feature computation module 530, a classification module 540, a post-processing module 550, and a final output 560.

Within the packet segregation module 510, both uplink and downlink packets at the UE are divided into a set of streams 515 based on a packet segregation rule. In this example, the set of streams 515 includes a first stream (Stream A) 515a, a second stream (Stream B) 515b, and a third stream (Stream C) 515c. The number (N) of streams within the set of streams 515 can vary, depending on characteristics of the packets.

The application-based packet segregation rule ensures that packets are homogeneous within each stream. For example, packets generated by the same application tend to belong to the same type of active application service and tend to share a similar traffic pattern. Such homogeneity is beneficial to the subsequent classification module 540. The packet segregation rule can be application-based or can be socket-based. A application-based packet segregation rule can be used so that packets in each stream are generated by a single application. A socket-based packet segregation rule can be used so that packets in each stream are generated by a single five-tuple socket. A five-tuple socket includes: a local-source IP address, a foreign-target IP address, a local-source port number, a foreign-target port number, and a transport layer protocol. Examples of the protocol include internet protocol (IP), user datagram protocol (UDP), transmission control protocol (TCP), or other suitable protocol.

In some embodiments of the set of streams 515, each respective stream includes a pre-processing filter 520 and a feature computation module 530. The N outputs from the set of streams 515 are input to a classification module 540, which includes ML-based per-stream classifiers 540a, 540b, or 540c and generates N ML predictions 545a-545c corresponding to the N streams. By including the per-stream classifiers, the classification module 540 can learn a pattern observed from one stream that exhibited the pattern, and later detect the learned pattern in another stream that has not yet exhibited the pattern. For ease of description, the classification module 540 or any of the per-stream classifiers 540a, 540b, or 540c.

In some embodiments of the set of streams 515, each respective stream includes a pre-processing filter 520, a feature computation module 530, and a per-stream classifier 540a, 540b, or 540c. The N outputs from the set of streams 515 are input to the post-processing module 550.

Each stream first passes through a pre-processing filter 520 to determine whether the stream is significant (for example, active) to proceed to be classified. If a stream is deemed significant, then UE the computes features based on the packets in the stream and performs a machine learning (ML) classification. That is, the pre-processing filter 520 controls whether to enable/disable the feature computation module 530 and a per-stream classifier 540a-540c to operate. For example, pre-processing filter 520 can determine the stream is significant based on satisfaction of a noise threshold condition, and enables the subsequent modules of the stream to operate based on the satisfied noise threshold condition. The noise threshold condition is satisfied when at least threshold number of packets arrive at the stream within a sliding window of time, for example, at least one packet within the past one second interval. The pre-processing filter 520 removes any background traffic that is sparse or unimportant. For example, if there are not any packets of traffic input to the pre-processing filter 520 within the sliding window of time, then the pre-processing filter 520 pauses or stops the subsequent modules of the stream until the stream becomes active again (for example, until the noise threshold condition is satisfied again).

The feature computation module 530 for each significant stream computes features 535. Packets within the significant streams pass through the pre-processing filter 520 of each stream and are input to the corresponding feature computation module 530, which analyzes the stream to extract features 535. More particularly, feature computation module 530 computes statistics of packets over every sampling window tₛₐₘₚₗₑ, and these statistics computed are the extracted features 535.

In some embodiments, the per-stream classifier 540a, 540b, or 540c applies a first machine learning (ML) model that has been trained to classify the respective stream 515a, 515b, or 515c into a set of classes, such as the six traffic classes listed in column 1 of Table 1. The ML prediction 545a, 545b, or 545c (generally 545) can represent the raw predicted traffic classes. Each ML prediction 545 is a vector output from the ML-based per-stream classifier 540a, 540b, or 540c, and the includes a predicted probability for each respective class c within the set C. p_{c} denotes the predicted probability for class c. The per-stream classifier 540a, 540b, or 540c generates ML predictions 545 continuously as packets arrive. Packets in a stream often arrive intermittently.

The post-processing module 550 generates and outputs a final output 560. The UE 116 keeps a history of the previous predictions for each stream. Using the post-processing module 550, the UE 116 performs prediction postprocessing over time as a historical analysis by combining current and previous predictions. As well, the post-processing module 550 performs prediction postprocessing across streams by combining predictions 545a-545c from multiple streams to obtain, as the final output 560, the final set of active application services being consumed currently. The final output 560 includes a final set of traffic classes that are detected as active, each detected traffic class mapped to a corresponding application services group being consumed currently. As such, the application service types within the corresponding application services group form (or approximate) the final set of active application services detected.

Note that the final set of “active” application services, which is the final output 560, is distinct from the set of different application service types, which is listed in Column 2 of Table 1. The set of different application service types (Column 2) includes all of the various services that the second ML model is trained to identify, without any regard to current consumption by the UE. The set of active application services (final output 560) includes only the different application service types currently consumed by the UE. That is, the final output 560 includes a subset of set of different application service types (Column 2).

In some embodiments, the per-stream classifier 540a, 540b, or 540c applies a second ML model that has been trained to classify the respective stream 515a, 515b, or 515c into a set of different application service types, such as the ten different application service types listed in column 2 of Table 1. The ML prediction 545 can represent the raw predicted application service types. For example, each element of the vector represents a likelihood or confidence value that the extracted features 535 are classified as a different one among the set of application service types. The set of active application services detected can be converted, using Table 1 as a map, to a set of active application services groupings (referred to interchangeably with “service class”). The final output 560 includes the final set of active application services detected.

FIG. 6 illustrates an example method 600 of packet segregation into bidirectional flows based on the TCP/IP five-tuple socket and the ML prediction for active streams, according to embodiments of this disclosure. The embodiment of the method 600 shown in FIG. 6 is for illustration only, and other embodiments could be used without departing from the scope of this disclosure. The procedure implemented by the packet segregation module 510 of FIG. 5 can include or can be the same as the method 600 of FIG. 6. The packet 602, packet segregation module 610, per-stream pre-processing filter 620, per-stream classifier 640, and ML prediction 645 of FIG. 6 can be the same as the corresponding components 502, 510, 520, 540, and 545 of FIG. 5.

In this example, the packet segregation rule is socket-based, and particularly based on the TCP/IP five-tuple and optionally the process ID (PID) information. The TCP/IP five-tuple can be extracted from packet headers, which are unencrypted unlike the packet payload. A bidirectional flow is defined as packets sharing a socket, namely sharing the TCP/IP five-tuple. The PID is a unique identifier for each application package installed on the mobile device.

Given that the operating system (such as OS 361 of FIG. 3) manages network packets on a per application basis, the operating system keeps track of the active applications that are generating network traffic and the sockets each active application is using. An active process may occupy one or more sockets and generate one or more flows. For example, video call applications such as WhatsApp™ may generate UDP flows carrying the call data together with multiple TCP flows. The PID information includes a list of the active PIDs as well as the TCP/IP five-tuples of the flows generated by each PID. Flows generated by the same PID are still separable because the flows have different TCP/IP five-tuples. Note that as an example only, the PID is used as a unique identifier. The UE does not need to know the exact name of the application.

In this example, the packet segregation module 610 within the UE 116 implements a packet filter such as the extended Berkeley Packet Filter (eBPF) to process the IP packet headers of ingress and egress packets 602 and to extract the TCP/IP five-tuple information. The packet filter also separates the packets 602 into streams 615_1 through 615_m(generally 615) based on the socket-based packet segregation rule. In this example, a stream 615 is defined as a bidirectional flow: group of UL and DL packets sharing the same TCP/IP five-tuple.

The UE, using the per-stream pre-processing filter 620, monitors when a stream 615 is open and closed. That is, the per-stream pre-processing filter 620 determines whether a stream 615 is active, namely open. Based on a determination that the steam 615 is open, the per-stream pre-processing filter 620 enables a per-stream classifier 640 to perform an ML-based classification to generate a current ML prediction 645. Based on an alternative determination that the steam 615 is closed, the per-stream pre-processing filter 620 uses a previous ML prediction 647 instead.

In some embodiments, each stream 615 includes packets 602 in a bidirectional flow. The packet filter separates packets based on their TCP/IP five-tuple. A TCP flow, such as first stream 615_1, is open when the establishment handshake packets (packets carrying the 3-way handshake with SYN and ACK flags) are observed. The TCP flow is closed when the closing handshake packets (packet carrying FIN flag) are observed. A UDP flow, such as m-th steam 615_m, is open when the first packet with a new TCP/IP five-tuple is observed and is closed when a timer expires (e.g., 5 seconds) after the last packet with the corresponding TCP/IP five-tuple has been observed.

A PID is active if it has at least one open flow, but the PID is inactive otherwise. Practically, the UE 116 does not need to monitor the IP packets 602 to determine the active/inactive status of a PID. Instead, the UE 116 can monitor the list of open sockets and their corresponding PIDs through network utility tools such as netstat. A PID is determined to be active if the PID has at least one open socket. Overall, the packets 602 are first separated based on their TCP/IP five-tuple into flows. With PID information, flows generated by the same PID can be combined.

Although FIG. 6 illustrates an example method 600 of packet segregation into bidirectional flows, various changes may be made to FIG. 6. For example, alternatively, a stream 615 can be a unidirectional flow that contains only the UL packets or only the DL packets from a bidirectional flow, with packets sharing the same local and foreign IP addresses, or with packets sent and received through any socket used by an application.

FIG. 7 illustrates a multi-sample sliding window 700 that includes a plural number of sampling windows (tₛₐₘₚₗₑ) 702, in accordance with an embodiment of this disclosure. The embodiment of the sliding window 700 shown in FIG. 7 is for illustration only, and other embodiments could be used without departing from the scope of this disclosure.

The procedure implemented by the feature computation module 530 of FIG. 5 can utilize the sliding window 700 of FIG. 7. As described herein, feature computation module 530 computes statistics of packets over every sampling window tₛₐₘₚₗₑ (such as sampling window 702), and these statistics computed are the features 535 extracted from every corresponding sample 704. That is, each sample 704 refers to the features 535 extracted from the stream 515 of packets over the sampling window 702. Each sample 704 is input to the per-stream classifier 540a, 540b, or 540c.

In some embodiments, the UE 116 continuously monitors the traffic from each stream (such as monitoring each packet that arrives) and predicts the traffic class. The features 535 are computed in a moving-window manner. The UE 116 computes the statistics of packets observed over every tₛₐₘₚₗₑ sampling window 702, including the average, maximum, minimum, variance, median absolute deviation (MAD), skew, percentiles and Kurtosis of the DL and DL packet size and inter-arrival times (IAT) of the UL, DL and bidirectional packets.

Each sample 704 captures the short-term traffic pattern over the previous tₛₐₘₚₗₑ seconds, while a longer-term pattern over t_{window} seconds is captured by concatenating

$$m = \frac{{t}_{window}}{{t}_{sample}}$$

samples, where t_{window} is an integer multiple of tₛₐₘₚₗₑ.

FIG. 8 illustrates an example transition 800 between the active state 802 and inactive state 804 of a stream, in accordance with an embodiment of this disclosure. The embodiment of the transition 800 shown in FIG. 8 is for illustration only, and other embodiments could be used without departing from the scope of this disclosure. The procedure implemented by each pre-processing filter 520 of FIG. 5 can utilize the transition 800 of FIG. 8.

Packets in a stream often arrive intermittently. It is challenging to classify the service type of a stream when there have been few recent packets. This disclosure defines an “active” state 802 and an “inactive” state 804 for each stream based on whether there has been significant traffic in the stream recently. A stream is in the inactive state 804 by default. If there has been at least n_{threshold} packets in the previous t_{active,1} seconds, the stream transitions into the active state 802. If there has been no traffic in an active stream for t_{active,2} seconds, the stream transitions into the inactive state 804. The time thresholds to determine the active state 802 of a stream can be the same as the sample time and window time such that t_{active,1}=tₛₐₘₚₗₑ and t_{active,2}=t_{window} or can be configured to be different values. That is, the t_{active,2} is a design parameter to determine when to disable (or switch off) the per-stream classifier (540a). The n_{threshold} and t_{active,1}. are design parameters to determine when to enable (or switch on) the per-stream classifier to receive each sample 704 as input and execute/apply an ML model to generate an ML prediction.

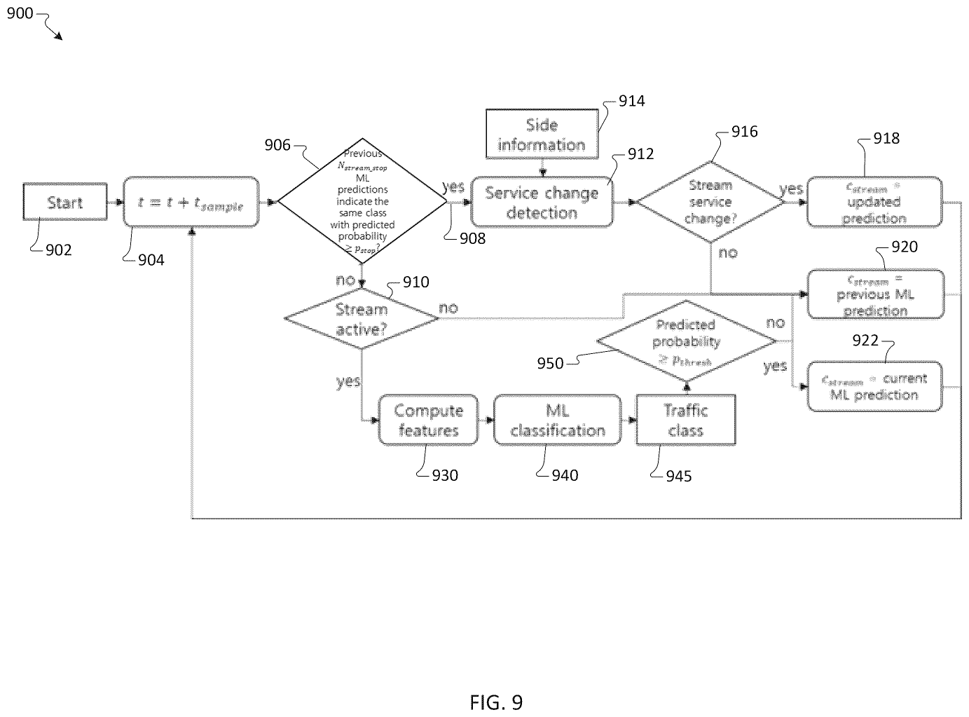

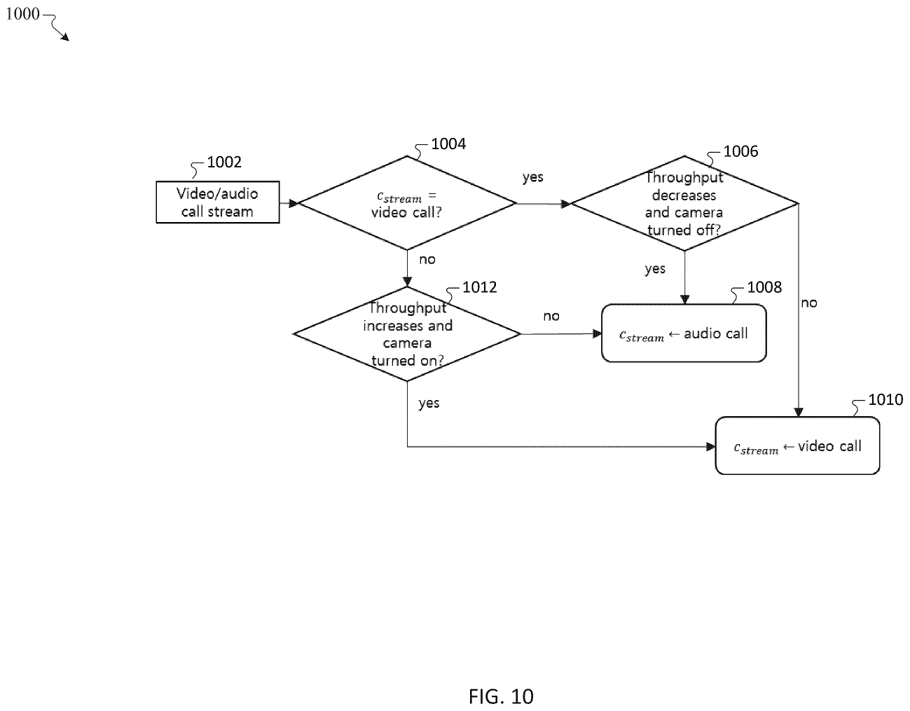

FIG. 9 illustrates an example method 900 for stream-level service prediction, in accordance with an embodiment of this disclosure. The embodiment of the method 900 shown in FIG. 9 is for illustration only, and other embodiments could be used without departing from the scope of this disclosure. The method 900 can be used by the UE 116 to reduce false positive outputs from an ML-based per-stream classifier 540a of FIG. 5. Most of the procedures in the method 900 can be implemented within the pre-processing filter 520.

The ML-based classifier 540a continuously makes predictions 545 of the traffic class for the stream as packets arrive. However, the ML predictions 545 are not guaranteed to be always correct. Using the raw ML predictions 545 output that include occasional prediction errors can lead to frequent and sub-optimal requests for the UE's preferred parameters.

A post-processing pipeline can be utilized within the post-processing module 550 to improve the robustness of the ML predictions 545, both for each stream and for the overall prediction for each PID. The post-processing module 550 applies post-processing techniques including: filtering ML predictions based on the confidence level, temporal filtering of predictions to remove occasional misclassifications, and cross-stream combining to obtain a robust prediction for each PID.

Executing the post-processing module 550, the UE 116 discards raw ML model predictions 545 that the UE 116 is not confident about to reduce false positives. The post-processing module 550 computes a predicted posterior probability of each traffic class within the set of traffic classes, which is for each element of the vector that is the raw ML prediction 545. The predicted posterior probability can be computing using the Softmax output from a neural network (NN) classifier. The method 900 describes how the traffic class of a stream is determined, if the predicted probability of the most likely class

$$p = {p}_{c}$$

is less than a threshold pₜₕᵣₑₛₕ, then the current classifier output is ignored and the most recent valid prediction is used.

By default, the UE 116 monitors all the packets in all streams, and continuously performs inference using the ML model to predict the real-time traffic class. Changes of the service type consumed within a stream is detected by the ML model as the traffic pattern changes accordingly. To reduce the operation complexity, the UE 116 may stop making predictions on a stream once the UE 116 is confident (i.e., a threshold confidence pₜₕᵣₑₛₕ condition is satisfied) with previous ML predictions. Once the ML classifier for a stream outputs a number N_{stream_stop} of consecutive predictions of the same service type where the predicted probability of the most likely class exceeds a threshold pₛₜₒₚ, the UE 116 stops computing features 535 and no longer performs ML classification on this stream. Instead, the stream is assumed to be generated by the previously predicted service type. In case of the rare occasions where the user consumes a different service on the same application, thereby causing the service type to change within a stream, the UE 116 executes a separate service-switching detection module.

At the start 902 of the method 900, one or more ML predictions 545 corresponding to a previous time (prior to the current time t) has been output from the per-stream classifier 540a and processed through the post-processing module 550. For each class c within the set C of traffic classes, the predicted probability p_{c} informs the UE 116 of how confident the classifier 540 is about the stream belonging to the class.

At block 904, the UE 116 updates a current sample 704 to include the packets arriving at a current time t. The packets arriving at a current time t are added to the sample 704 that the feature computation module 530 is currently generating.

At block 906, a determination is made for whether a number N_{stream_stop} of previous ML predictions indicate the same class with a prediction probability p_{c} that is greater than a threshold confidence pₛₜₒₚ. This determination can be made by pre-processing filter 520, in some embodiments. The UE 116 pauses output from the ML-based classifier 540 based on an affirmative determination 908 that the threshold confidence pₛₜₒₚ is exceeded. Alternatively, a negative determination leads to block 910.

The affirmative determination 908 triggers the UE 116 to perform service change detection. For example, the UE 115 can execute a service change detection module 912 to determine if a user has begun using a different application service type. A change of active services of a stream can be detected based on side information 914.

At block 916, the UE determines whether a change to the application service types consumed within an active stream occurred. At block 918, based on the change that occurred, the traffic classification for the stream cₛₜᵣₑₐₘ is set as the updated ML prediction 545 that corresponds to the current time t. After updating the traffic classification cₛₜᵣₑₐₘ corresponding to the current time t, the workflow returns to block 904.

At block 920, based on a determination that no change occurred, the traffic classification for the stream cₛₜᵣₑₐₘ remains set at the previous ML prediction. Also at block 920, the post-processing module 550 discards the output from ML classifier 540a, discarding the updated ML prediction 545 corresponding to a current time t. After setting the traffic classification C stream corresponding to the current time t, the workflow returns to block 904.

At block 910, a pre-processing filter determines whether the stream is active. If the stream is not in the active state 802, then the method 900 proceeds to block 920. If the stream is in the active state 802, then the packets corresponding to the current time t are processed through subsequent modules 930 and 940 of the per-stream pipeline. The subsequent modules 930 and 940 and the ML prediction 945 and can be similar to corresponding components 530, 540, and 545 the of FIG. 5.

At block 950, the post-processing module determines whether the predicted probability of the most likely class

$$p = {p}_{c}$$

is greater than or equal to (i.e., not less than) a threshold pₜₕᵣₑₛₕ, in order to determine to discard (at block 920) or to utilize (at block 922) the ML prediction 945 output from the ML classification module 940.

FIG. 10 illustrates an example method 1000 for detecting a service change based on an audio/video call stream, in accordance with an embodiment of this disclosure. The embodiment of the method 1000 shown in FIG. 10 is for illustration only, and other embodiments could be used without departing from the scope of this disclosure. The method 1000 of FIG. 10 can be executed as part of the procedure at block 916 of FIG. 9. The method 1000 of FIG. 10 can be executed by a service-switching detection module within the UE, as introduced herein.

A common scenario where the service type changes within the flow is during WebRTC applications such as video or audio calls. If the user enables or disables video during the call, the flow carrying the traffic does not change even when the underlying service is different. The in-stream service change detection module monitors (at block 1002) the UL and DL throughput of the stream as well as side information (such as side information 914). Examples of side information include the on/off status of the camera of the UE and microphone 320 on the device.

A stream that the ML classifier 540 has classified as a video call is determined to have switched to audio call if the throughput decreases and the camera is turned off. A stream classified as audio call service type is determined to have switched to video call if the throughput increases and the camera is turned on.

At block 1004, the service-switching detection module determines whether a stream has been classified as currently consuming a video call service type. If the stream is classified as a video call, then the method proceeds to block 1006. At block 1006, the service-switching detection module determines whether both of the following are TRUE for the stream: throughput decreases, and the camera is turned OFF. If both are true at block 1006, the method proceeds to block 1008, else, the method proceeds to block 1010. At block 1008, the service-switching detection module determines that application service type currently consumed by the stream switched (i.e., changed) from video call to audio call. At block 1010, the service-switching detection module determines that application service type currently consumed by the stream switched from audio call to video call. At block 1012, in response to a determination that the stream has not been classified as a video call, the service-switching detection module determines whether both of the following are TRUE for the stream: throughput increases, and the camera is turned ON. If both are true at block 1012, the method proceeds to block 1010, else, the method proceeds to block 1008.

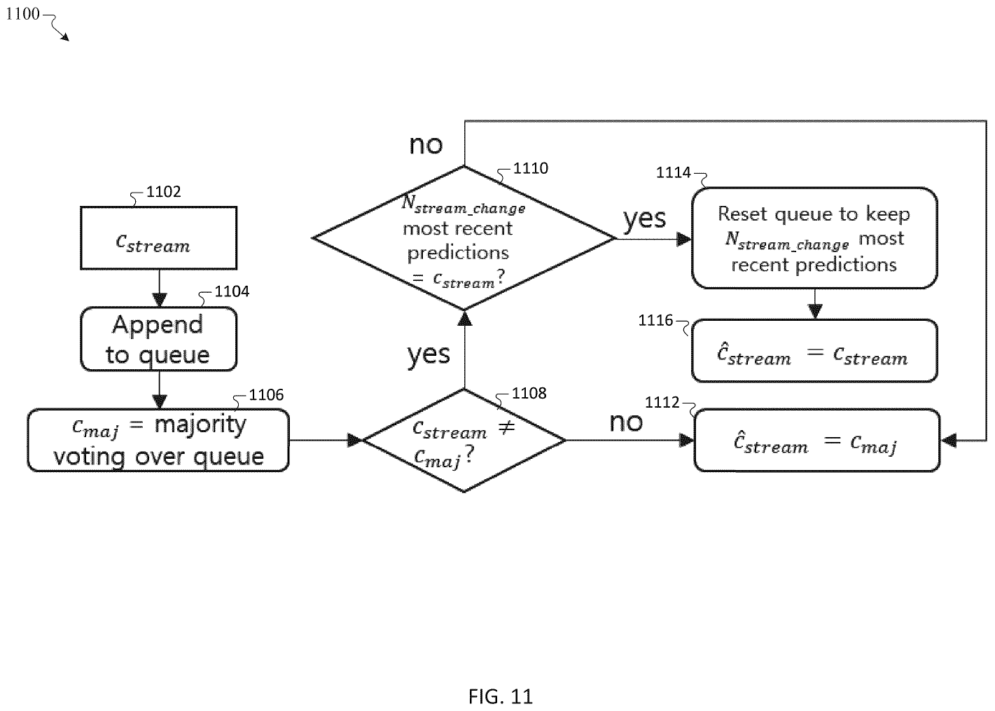

FIG. 11 illustrates an example method 1100 of temporal filtering of per-stream predictions, in accordance with an embodiment of this disclosure. The embodiment of the method 1100 shown in FIG. 11 is for illustration only, and other embodiments could be used without departing from the scope of this disclosure.

The temporal filtering method 1100 is applied to the raw per-stream predictions, which include a sequence of predicted traffic class output cₛₜᵣₑₐₘ from the method 900 of FIG. 9. The predicted traffic class output cₛₜᵣₑₐₘ 1102 corresponding to the current time t is output from one block from among blocks 918, 920, and 922 of FIG. 9.

Packets in a flow are generated by the same application and typically the same service type. As an example, a bidirectional flow defines the stream 615_1 of FIG. 6. The UE keeps a size-N_{stream_filter} FIFO queue for each stream to record the most recent predictions. The filtered per-stream prediction at each time step is obtained from a majority vote over the previous N_{stream_filter} predictions. The per-stream temporal filtering aims to remove the occasional classification errors from the ML model. If the underlying application service being consumed changes within the same stream (e.g., when the user enables video in a previously audio-only call on WhatsApp™ application), the raw output from the classifier could change accordingly. This ability a single per-stream classifier 540a to output two consecutive ML predictions 545 that cause corresponding the predicted traffic class outputs cₛₜᵣₑₐₘ to be different from each other might be considered a desirable speed of responsiveness for some use cases, but in other use cases might be considered an undesirable instability of the predicted traffic class outputs cₛₜᵣₑₐₘ.

For use cases that desire to avoid instability, the temporal filtering method 1100 introduces a delay of

$$⌈ \frac{{N}_{stream \_ filter}}{2} ⌉$$

until the new service is detected. The temporal filtering window N_{stream_filter} could be tuned according to the desired tradeoff between prediction consistency and sensitivity to in-stream service changes. Additionally, to reduce this delay of

$$⌈ \frac{{N}_{stream \_ filter}}{2} ⌉ ,$$

it the most recent number N_{stream_change} of consecutive ML predictions 545 indicate a new traffic class, and where

$${N}_{stream \_ change} < ⌈ \frac{{N}_{stream \_ filter}}{2} ⌉ ,$$

then the UE 116 resets the queue to contain the most recent N_{stream_change} predictions.

At block 1104, the cₛₜᵣₑₐₘ 1102 appends to the size-N_{stream_filter} FIFO queue. At block 1106, the UE 116 computes cₘₐⱼ that denotes a majority vote over the queue. In the queue a sequence is recorded, and the sequence includes a number N_{stream_filter} of the previous predicted traffic class outputs cₛₜᵣₑₐₘ. At block 1108, the UE 116 determines whether the cₛₜᵣₑₐₘ 1102 is different from the majority vote cₘₐⱼ. If the cₛₜᵣₑₐₘ 1102 is not equal to the majority vote cₘₐⱼ, then the method 1100 proceeds to block 1110 to determine whether the cₛₜᵣₑₐₘ 1102 is equal to the N_{stream_change} most recent predicted traffic class outputs cₛₜᵣₑₐₘ. If the cₛₜᵣₑₐₘ 1102 is equal to the N_{stream_change} most recent predicted traffic class outputs cₛₜᵣₑₐₘ, then the method proceeds to block 1114, else the method proceeds to block 1112. The temporally-filtered per-stream class is denoted as ĉₛₜᵣₑₐₘ. At block 1112, the ĉₛₜᵣₑₐₘ is set equal to the majority vote cₘₐⱼ. At block 1114, the UE 116 resets the FIFO queue to keep the N_{stream_change} most recent predicted traffic class outputs cₛₜᵣₑₐₘ. At block 1116, the ĉₛₜᵣₑₐₘ is set equal to the cₛₜᵣₑₐₘ 1102.

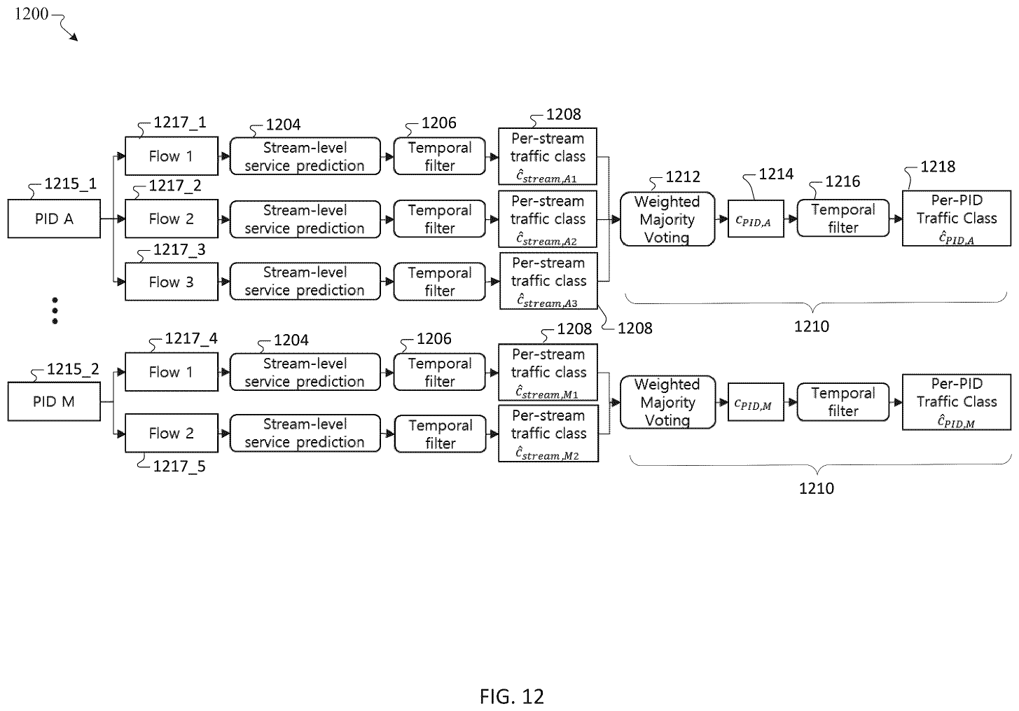

FIG. 12 illustrates an example method 1200 of combining per-flow predictions to obtain the per-PID prediction, in accordance with an embodiment of this disclosure. The embodiment of the method 1200 shown in FIG. 12 is for illustration only, and other embodiments could be used without departing from the scope of this disclosure. The method 1200 combines the predictions obtained for different streams belonging to the same PID into a single per-PID prediction.

In this example, the packet segregation module divides packets into a first set of streams 1215, referred to as per-PID streams 1215_1 and 1215_2 (illustrated as PID A and PID B), based on a PID of each packet. Further, the packet segregation module divides the packets into a second set of streams 1217, referred to as per-flow streams 1217_1 through 1215_5, based on a socket of each packet. For each respective per-PID stream 1215, the packet segregation module identifies a number of flows associated with the same PID, and subdivides the respective per-PID stream 1215 into the number of per-flow streams 1217. That is, each respective per-PID stream 1215 includes a subset of the per-flow streams 1217 that share the identified PID that corresponds to the respective stream. For example, a first per-PID stream 1215_1 includes one subset of the per-flow streams 1217_1 through 1215_3, while a second per-PID stream 1215_2 includes another subset of the per-flow streams 1217_4 through 1215_5.

Each per-flow stream 1217 feeds into a per-PID stream-level service prediction pipeline 1204 at the post-processing portion. The stream-level service prediction pipeline 1204 can include some of the components of the pipeline 500 of FIG. 5, including the pre-processing filter 520, feature computation module 530, classification module 540, and post-processing module 550.

The stream-level service prediction pipeline 1204 includes a temporal filter 1206 that can perform the method 1100 (FIG. 11) of temporal filtering of per-stream predictions. The temporal filter 1206 outputs a temporally-filtered per-stream class 1208. As an example, the temporally-filtered per-stream class 1208 is denoted as ĉ_{stream,A3} for a third per-flow stream 1217_3 (corresponding to Flow 3) within the first per-PID stream 1215_1 (corresponding to PID A).

Each per-PID stream 1215 includes a cross-stream post-processing pipeline 1210 that includes weighted majority voting module 1212 that generates a per-PID prediction 1214 (denoted as ĉ_{PID,A} Or ĉ_{PID,M}), and a temporal filter 1216 that outputs a temporally-filtered per-PID class 1218 (also referred to as a per-PID label). The weighted majority vote module 1212 that can perform the procedures of block 1106 of FIG. 11.

The temporal filter 1216 can be the same as or similar to the temporal filter 1206, and both prevent flip-flopping (such as too-frequent changes) of the temporally-filtered class @ 1208, 1218. In this example, the method 1200 includes one performance of temporal filtering via the per-flow temporal filter 1206, and another performance of temporal filtering via the per-PID temporal filter 1216.

The PID is a unique identifier for each application 362 on the UE 116. The user of the UE 116 typically consumes a single type of service when using one application at any given time, packets in all the flows associated with one PID are typically generated by the same service type. The filtered per-stream traffic class predictions ĉₛₜᵣₑₐₘ for all streams belonging to the same PID are combined to obtain a per-PID traffic class prediction according to the method 1200. While modern applications often keep multiple flows open simultaneously, not all flows are equally representative for the application service type being consumed. To obtain (for example, generate a per-PID label 1218 of) a single traffic class for an active application 362, the predicted classes 1208 from the subset of per-flow streams 1217 (corresponding to the application's 362 PID) are combined by weighted majority voting 1212 based on the data volume of each per-flow stream. As shown in Equation 1, the final prediction 1218 for each PID is the traffic class with the most total packet size in the corresponding subset of flows (such as 1217-1 to 1217_3), where c_{PID} is the predicted traffic class for the PID, [symbol] is the set of all traffic classes, [symbol] _{PID} is the set of all open streams generated by the PID, rₛ is the total UL and DL packet size in stream s in the previous t_{window} seconds, αₛ is a weighting factor for stream s and f(s) is the predicted traffic class for stream s. The weighting factor as can be determined based on the stream type. For instance, data packets representative of real-time traffic (e.g., audio/video call, online gaming) are typically carried in UDP flows. Accordingly, a small αₛ could be assigned to TCP flows while a large αₛ is assigned to UDP flows to magnify the presence of real-time traffic.

$${c}_{PID} = {α}_{s} {r}_{s} {\{ f ( s ) = c \}}_{} \qquad ( 1 )$$

At this stage, by executing the method 1200, the UE 116 obtains a predicted traffic class for each active PID. The set of service types the UE 116 is currently consuming, which includes ĉ_{PID,A} through ĉ_{PID,M}, is the set of traffic classes across all the UE's 116 active PIDs.

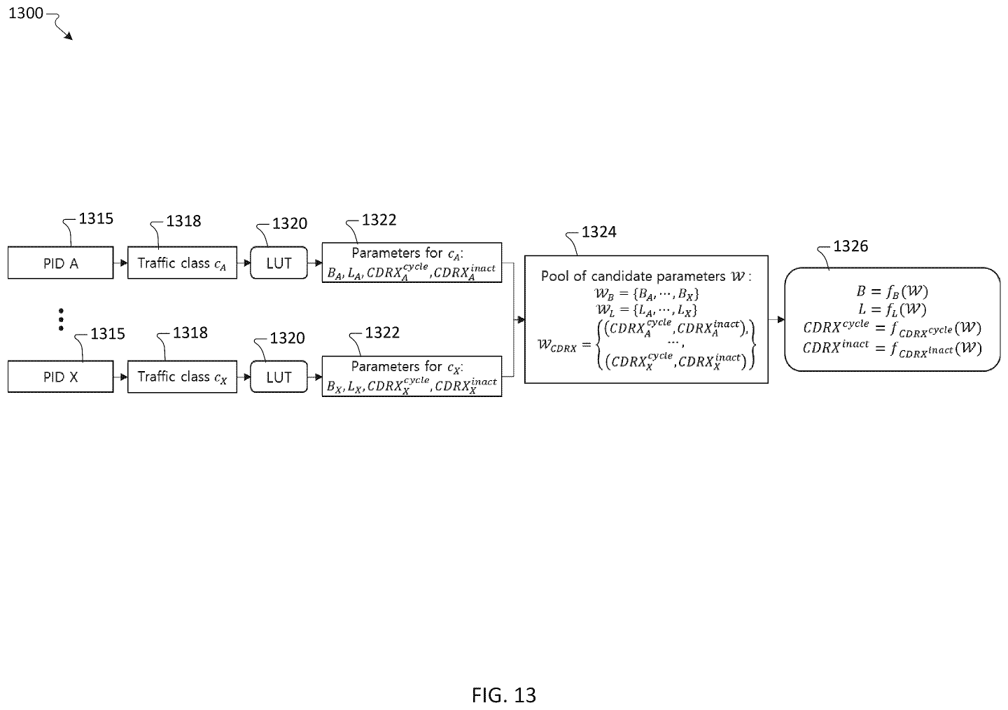

FIG. 13 illustrates an example method 1300 of temporal filtering of per-PID predictions, in accordance with an embodiment of this disclosure. The embodiment of the method 1300 shown in FIG. 13 is for illustration only, and other embodiments could be used without departing from the scope of this disclosure. The method 1300 enables the UE 116 to select a power-saving configuration.

The method 1300 can be a processing pipeline that includes a set of per-PID streams 1315 (e.g., stream for PID A through stream for PID X) that respectively generate a set of per-PID classes 1318, which can be the same as or similar to the corresponding components 1215 and 1218 of FIG. 12. The processing pipeline for the method 1300 includes a look-up table (LUT) 1320 for each per-PID stream, which enables the UE 116 to select per-stream parameters 1322. The method 1300 generates a pool of candidate parameters 1324 that includes a combination of the per-stream parameters 1322 from each stream among the set of per-PID streams 1315. The method 1300 includes a mixed-service configuration selection 1326 at which the UE 116 selects, based on the set of traffic classes 1318, a set of UAI parameters that reduce power consumption of the UE while maintaining a QoS level. In some implementations of the method 1300, there is no need to have a mapping function (such as f( ) for preferred minimum scheduling offset for cross-slot scheduling.

The optimal parameters should minimize power consumption while achieving the QoS requirements given the active services. A set of candidate configurations is selected as a subset from among a set of all possible combinations of parameters to reduce the search complexity. During deployment, the UE selects its preferred configuration from a look-up table (LUT) 1320, which maps the channel condition and active services to the optimal configuration.

To construct this LUT, the power consumption and QoS achieved by all candidate configurations in all channel conditions need to be evaluated for applications in each traffic class. The power consumption and QoS evaluation can be obtained through link-level simulation or through field measurements. The channel condition categorization could be based on quantized past channel measurements, such as the CQI-RI pair or average RSRP. In one embodiment, the LUT may describe a mapping from all service combinations to their optimal configuration given the channel condition. To construct this LUT, the power consumption and QoS of all service combinations and configurations need to be evaluated. Alternatively, the LUT may contain the optimal configuration for each single service. A further mixed-service configuration selection step is performed when mixed service is present. This reduces the LUT size and the amount of evaluations needed to construct the LUT.

The mixed-service configuration selection 1326 is illustrated in FIG. 13, where B is the bandwidth, L is the maximum number of MIMO layers, CDRX^{cycle}, CDRX^{inact} are the CDRX cycle duration and inactivity timer. The impact on the QoS can be decomposed according to the parameters in the configuration: the BW and number of MIMO layers dominates the UE-experienced throughput while the latency is largely affected by the CDRX parameters assuming the throughput requirement has been met. Hence, the UE obtains the optimal parameters for each active service from its LUT which form a pool of candidate parameters 1324. The final parameters are determined based on mappings f( ) from the pool of candidate parameters [symbol] . There are multiple ways to obtain the final parameters to request for the UE. A general principle is that the combination of parameters should meet the QoS requirement of each of the active services. In one embodiment, the UE 116 then selects the maximum BW, maximum number of MIMO layers and smallest CDRX UE-off duration from the pool, according to Equations 2, 3, and 4.

$$B = {max}_{i} {B}_{i} \qquad ( 2 )$$

$$L = {max}_{i} {L}_{i} \qquad ( 3 )$$

$$C D R {X}^{cycle} , C D R {X}^{inact} = {arg min}_{{CDRX}_{i}^{cycle} , {CDRX}_{i}^{inact}} C D R {X}_{i}^{cycle} - C D R {X}_{i}^{inact} \qquad ( 4 )$$

In another embodiment, the bandwidth and number of MIMO layers are derived from the sum of the parameters for each PID, whereas the minimum CDRX cycle duration and maximum CDRX inactivity timer are chosen according to Equations 5, 6, 7, and 8.

$$B = min ( {\sum }_{i} {B}_{i} , {B}_{m ax} ) \qquad ( 5 )$$

$$L = min ( {\sum }_{i} {L}_{i} , {L}_{m ax} ) \qquad ( 6 )$$

$$C D R {X}^{cycle} = {min}_{i} C D R {X}_{i}^{cycle} \qquad ( 7 )$$

$$C D R {X}^{inact} = min ( {max}_{i} C D R {X}_{i}^{inact} , C D R {X}^{cycle} ) \qquad ( 8 )$$

Alternatively, the bandwidth and number of MIMO layers are determined based on their product, which acts as an estimate of the achievable link capacity:

$$L , B = {arg min}_{\hat{L} , \hat{B}} ( \hat{L} \hat{B} \vert \hat{L} \hat{B} \geq {\sum }_{i} {λ}_{i} {L}_{i} {B}_{i} ) \qquad ( 9 )$$

The bandwidth and number of MIMO layers are chosen to achieve the minimum capacity that is higher than the total throughput required by active PIDs. The parameters λᵢ are scaling factors, which can be chosen proportionately based on the amount of traffic in each PID or based on the importance of the traffic class.

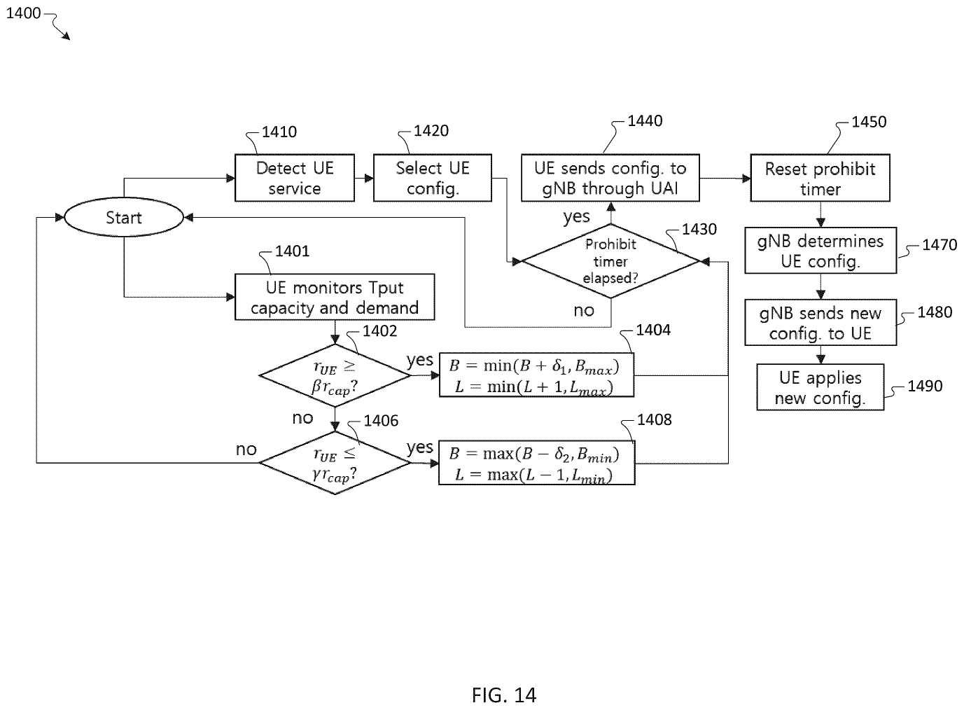

FIG. 14 illustrates an example method 1400 of selecting a UE-preferred configuration for mixed-service, in accordance with an embodiment of this disclosure. The embodiment of the method 1400 shown in FIG. 14 is for illustration only, and other embodiments could be used without departing from the scope of this disclosure. The method 1400 can be used with components of the processing pipeline that is the method 1300 of FIG. 13. The UE 116 executes the method 1400 as a QoS safeguard mechanism.

The method 1400 provides an additional configuration refinement loop that maintains the UE's QoS even during anomaly events. Examples of anomaly events occur include: an occurrence when incorrect traffic classes are predicted, sudden changes in channel conditions or network conditions, and atypical application traffic requirements.

As illustrated in the method 1400, at block 1401, the UE monitors the average link capacity r_{cap} and its experienced throughput r_{UE} over the last t seconds. The link capacity and experienced throughput represent the “supply” and “demand” of data rate. The link capacity is the maximum data rate supported by the BS given the current resource allocation and UE configuration and can be estimated using Equation 10 or Equation 11 based on the channel measurements such as SINR, CQI, RI, the modulation order Q and coding rate R from the assigned MCS.

$${r}_{cap} = ( RI + 1 ) \times B \times log ( 1 + SINR ) \qquad ( 10 )$$

$${r}_{cap} = L \times Q \times R \times \frac{{N}_{PRB} \times 12}{{T}_{s}} \times ( 1 - OH ) \qquad ( 11 )$$

The experienced throughput refers to the actual data rate generated by the active services. At block 1402, if the experienced throughput is greater than a percentage β of the link capacity, then UE increases (at block 1404) the bandwidth by δ₁ MHz and/or increases the maximum number of MIMO layers by 1 because there is insufficient margin in the capacity, and QoS may suffer as a result of the insufficient margin. At block 1406, if the experienced throughput is less than a percentage γ of the link capacity, where (γ<β), then UE decreases at block 1408) the bandwidth by δ₂ MHz and/or decreases the maximum number of MIMO layers by 1. The apriori UE parameters are likely to be over-configured such that there is more room for power saving.

This process of configuration refinement loop (blocks 1404-1410) occurs in parallel to the procedures of UE service detection (at block 1410) and the procedure of UE configuration selection (at block 1420). Blocks 1410, 1420, 1430, 1440, 1450, 1470, 1480, and 1490 can include the same as corresponding blocks 410, 420, 430, 440, 450, 470, 480, and 490 of FIG. 4. The method proceeds to block 1430 from block 1404 and block 1408, after the tuning the bandwidth and the MIMO layers. In parallel, method proceeds to block 1430 from block 1420. At block 1430, if the prohibit time has not yet elapsed, the method 1400 restarts.

The thresholds β, γ and bandwidth adjustment steps δ₁, δ₂ can be tuned to adjust how aggressive the safe-guarding mechanism of method 1400 is. For instance, the UE 116 selects a smaller β and larger δ₁ to allow the UE to increase its capacity more aggressively (sooner and by a larger amount) when the experienced throughput increases. The UE 116 selects a smaller γ and δ₂ to allows the UE to slowly and gradually decrease its capacity (and save more power) when the experienced throughput decreases. Such a combination of β, γ, δ₁, δ₂ is more likely to ensure the UE's QOS is maintained in compliance with requirements of the active applications.

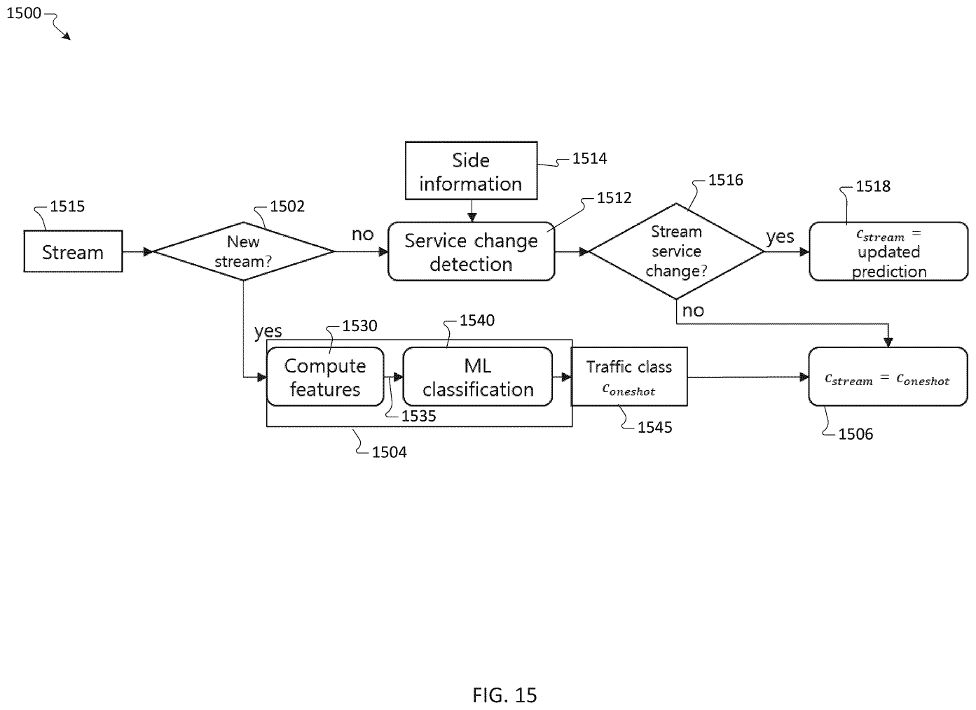

FIG. 15 illustrates a method 1500 of stream-level service prediction with one-shot ML classification that includes a second example processing pipeline for UE service detection, in accordance with an embodiment of this disclosure. The embodiment of the method 1500 shown in FIG. 15 is for illustration only, and other embodiments could be used without departing from the scope of this disclosure. The UE 116 executes the method 1500 to reduce computational complexity associated with determining the per-stream class cₛₜᵣₑₐₘ, and to compute the per-stream class cₛₜᵣₑₐₘ less frequently (for example, at a frequency period greater than 500 milliseconds) than every sampling window tₛₐₘₚₗₑ.

The method 1500 can be executed for each respective stream 1515 among a set of streams. The stream 1515 can represent a stream from among the set of streams 515 of FIG. 5, 615 of FIG. 6, 1215 or 1217 of FIG. 12, or 1315 of FIG. 13.

At block 1502, the UE 116 determines whether the stream 1515 is a new stream. If the stream 1515 is new, then at block 1504, the UE performs stream-level service prediction to determine an initial traffic class cₒₙₑₛₕₒₜ 1545. The procedure block 1504 can include some of the components of the pipeline 500 of FIG. 5, including the pre-processing filter 520, feature computation module 530, classification module 540, and post-processing module 550 of FIG. 5. The initial traffic class cₒₙₑₛₕₒₜ 1545, which is also referred to as a one-shot ML classification, can be the same as or similar to the ML prediction 545 of FIG. 5. In some embodiments, block 1504 can be the same as the procedure of the stream-level service prediction pipeline 1204 of FIG. 12. At block 1506, the UE updates the per-stream class cₛₜᵣₑₐₘ to be the same as the initial traffic class cₒₙₑₛₕₒₜ 1545.

Alternatively, if the UE 116 determines the stream 1515 is not new, but instead previously established, the method 1500 proceeds to block 1512. The method 1500 includes blocks 1512, 1514, 1516, and 1518 which can incorporate be the same as blocks 912, 914, 916, and 918 of FIG. 9, respectively. If the UE 116 determines that that no change occurred at block 1516, then the method 1500 proceeds to block 1506. At block 1506, the traffic classification for the stream cₛₜᵣₑₐₘ remains set at the previous ML prediction, which is the initial traffic class cₒₙₑₛₕₒₜ 1545. At block 1516, a determination that the no change of service occurred within the stream 1515 enables the UE to bypass the stream-level service prediction block 1504.

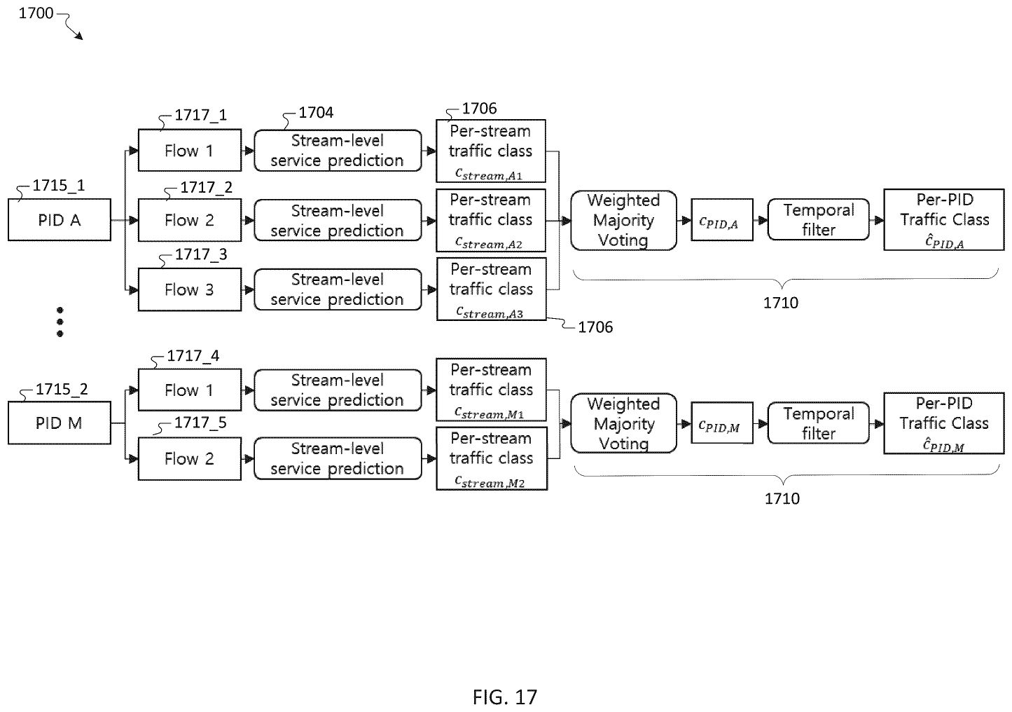

The stream-level service prediction block 1504 includes a feature computation module 1530 and a classification module 1540. For each new stream, the feature computation module 1530 computes features 1535 using the first N packets arriving into the stream 1515. The features 1535 include packet statistics: the mean, maximum, minimum, skew, Kurtosis of packet size and IAT, the differentiated services field in the IP header, whether the flow is TCP or UDP, and the number of packets with the PSH flag in the TCP header. The raw TCP/IP header bitmap is transformed into a feature by padding and reshaping into a 2D image where each pixel is 1 or 0. Padding is required when the header bitmaps have different lengths. The transformed header bitmaps are shown in FIG. 17 as header bitmap features 1606. The computed features 1535 are input to the ML classification model within the classification module 1540.

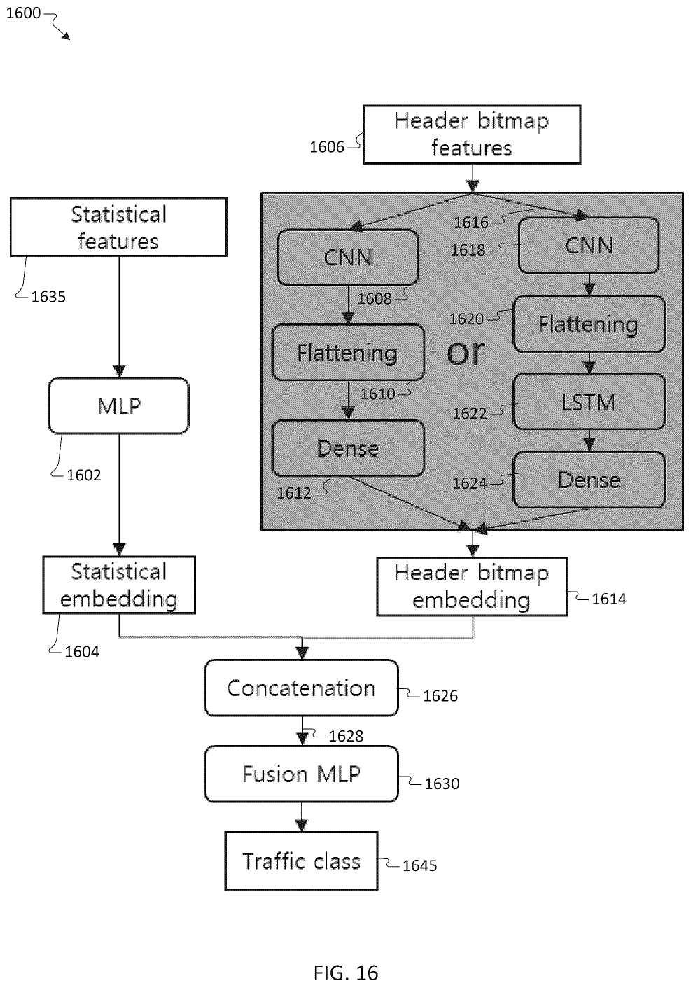

FIG. 16 illustrates an architecture of an ML classification model that includes a multi-modality fusion model 1600, in accordance with an embodiment of this disclosure. The embodiment of the multi-modality fusion model 1600 shown in FIG. 16 is for illustration only, and other embodiments could be used without departing from the scope of this disclosure. The multi-modality fusion model 1600 can represent the classification module 540 of FIG. 5 or 1540 or FIG. 15. The multi-modality fusion model 1600 receives the statistical features 1635 as input from a feature computation module. The statistical features 1635 can represent the features 535 of FIG. 5 or 1535 or FIG. 15.

The multi-modality fusion model 1600 includes a multilayer perceptron (MLP) 1602. The MLP 1602 is a feedforward fully connected neural network (NN). The statistical features 1635 are processed by the MLP 1602 to produce a statistical embedding vector 1604.

The transformed header bitmaps features 1606 are stacked so that the header bitmap of the first N packets form an image with N channels. The stacked bitmaps are then passed into a convolutional neural network (CNN) 1608 whose outputs are flattened 1610 and passed through a fully connected layer 1612 to produce the head bitmap embedding vector 1614.

Alternatively, the bitmaps features 1606 are reshaped into a length-N sequence of 2D images 1616 and passed into a CNN-LSTM network to extract the spatial and temporal information. The CNN-LSTM network first use a CNN module 1618 to transform each 2D image into a vector of extracted spatial features, which can be flattened 1620. The sequence of spatial features is then processed by the long short-term memory (LSTM) 1622 and a fully connected layer 1624 to obtain the embedding vector 1614 for the header bitmaps.

The embedding vectors 1604 and 1614 of the two input modalities are then concatenated 1626 to generate a complete feature 1628, which is passed through a fusion MLP NN 1630 to obtain the predicted traffic class label 1645. The predicted traffic class label 1645 can represent the MP prediction 545 of FIG. 5 or the initial traffic class cₒₙₑₛₕₒₜ 1545 of FIG. 15.

FIG. 17 illustrates another example processing pipeline 1700 for UE service detection that includes a post-processing pipeline for one-shot stream-level predictions, in accordance with an embodiment of this disclosure. The embodiment of the processing pipeline 1700 shown in FIG. 17 is for illustration only, and other embodiments could be used without departing from the scope of this disclosure.

The processing pipeline 1700 is similar to the pipeline within method 1200 of FIG. 12, except this one-shot processing pipeline 1700 of FIG. 17 does not include temporal filtering for the per-flow streams 1717_1 through 1717_5 (generally 1717), thereby excluding the temporal filters 1206 of FIG. 12. Within each per-flow stream 1717, a stream-level service prediction pipeline 1704 performs the method 1500 of FIG. 15, which includes monitoring the packets to determine if the application service type of the per-flow stream changes after the initial one-shot classification cₒₙₑₛₕₒₜ is set as the per-stream class at block 1706. As an example at block 1706, the per-stream class is denoted as c_{stream,A3} for a third per-flow stream 1717_3 7 within the first per-PID stream 1715_1, and the c_{stream,A3} is set equal to the one-shot classification cₒₙₑₛₕₒₜ. That is, block 1706 is similar to block 1506 of FIG. 15.

For each per-PID stream 1715_1 through 1715_2, the post-processing pipeline 1700 includes a cross-stream post-processing pipeline 1710 that can be the same as or similar to the pipeline 1210 of FIG. 12. A similar weighted majority voting procedure is used to combine the per-stream predictions (such as c_{stream,A3} output from block 1706), and a similar temporal filtering procedure is used to filter the per-PID predictions (denoted as c_{PID,A} Or c_{PID,M}).

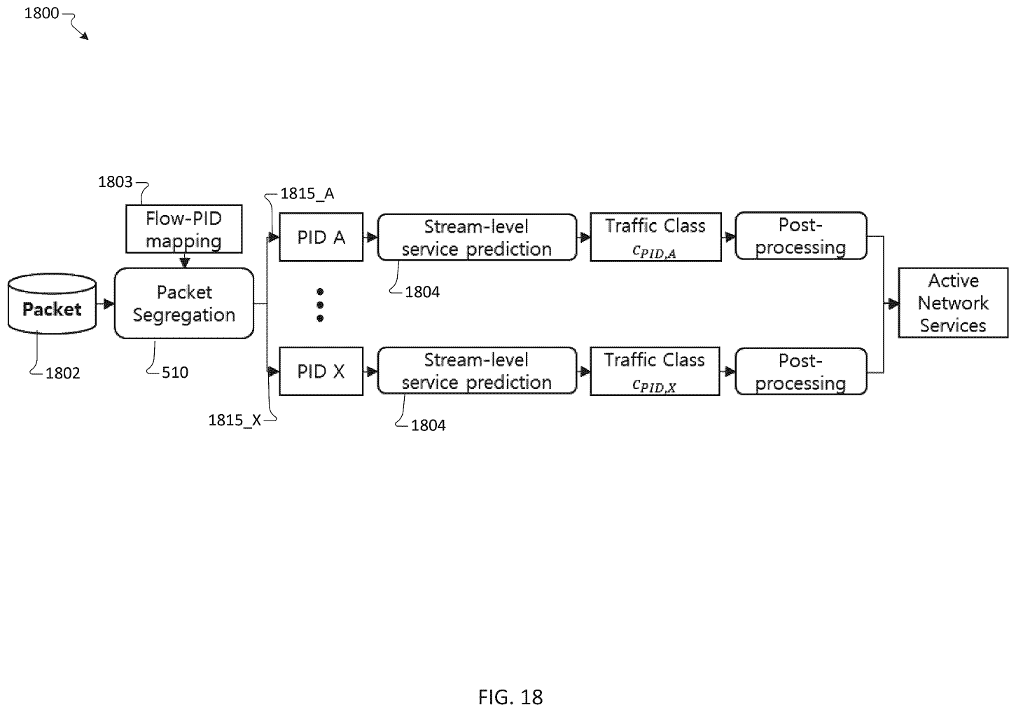

FIG. 18 illustrates a third example processing pipeline 1800 for UE service detection based on a PID-aggregated service detection design, in accordance with an embodiment of this disclosure. The embodiment of the pipeline 1800 shown in FIG. 18 is for illustration only, and other embodiments could be used without departing from the scope of this disclosure.

In the processing pipeline 1800 of FIG. 18, a stream 1815 is defined as a unidirectional flow. This is in comparison to the processing pipelines 600, 1200, and 1700 of FIGS. 6, 12, and 17, that define a stream as a bidirectional flow and that perform and generate an ML prediction for each bidirectional flow.

In the processing pipeline 1800, packets 1802 of traffic that ingress and egress at the UE 116 are monitored. The processing pipeline 1800 includes a packet segregation module 1810 that divides the packets 1802 into a set of streams 1815. To further reduce the complexity, the PID information is used during packet segregation 1810 instead of during post-processing, so that each stream 1815 is defined as all packets from a PID (such as PID A through PID X). That is, each stream 1815 is a PID-aggregated stream. Practically, this requires the UE 116 to obtain all flows generated by each PID and to generate a flow-PID mapping 1803. By cross-referencing the TCP/IP 5-tuple socket contained in the packet headers, the UE 116 aggregates packets from all flows generated by each PID. Consequently, the processing pipeline 1800 also does not require the cross-stream combining procedure (such as 1210 of FIG. 12 or 1710 of FIG. 17), thereby further reducing complexity. As an example, each stream 1815 can correspond to the application 363 that generated the packet.

At this stage, the UE can execute a stream-level service prediction 1804 for each of the PID-aggregated stream streams 1815, and this includes applying the ML classification model (such as the ML classification module 540 of FIG. 5) on each stream 1815. Given that there are fewer active PIDs than flows, the computation complexity due to feature computation and ML inference is reduced. The stream-level service prediction 1804 can include the same or similar features and ML classifier architectures as the designs of: continuous-prediction embodiments like FIG. 5 and FIG. 12; or the one-shot classification embodiments like FIGS. 15 and 17. That is, within the stream-level service prediction 1804, ML model can predict the traffic class continuously when the stream 1815 is active or in one-shot at the beginning for a new stream. Additionally, the stream-level service prediction 1804 can incorporate the service-change detection module 912, 1512 described in FIG. 9 and FIG. 15. The stream-level service prediction 1804 can include the same temporal filtering procedure of per-PID predictions in the method 1100 of FIG. 11, which can be used in the post-processing step if the continuous-prediction design is adopted (instead of the one-shot classification design), to improve the consistency of the predictions.

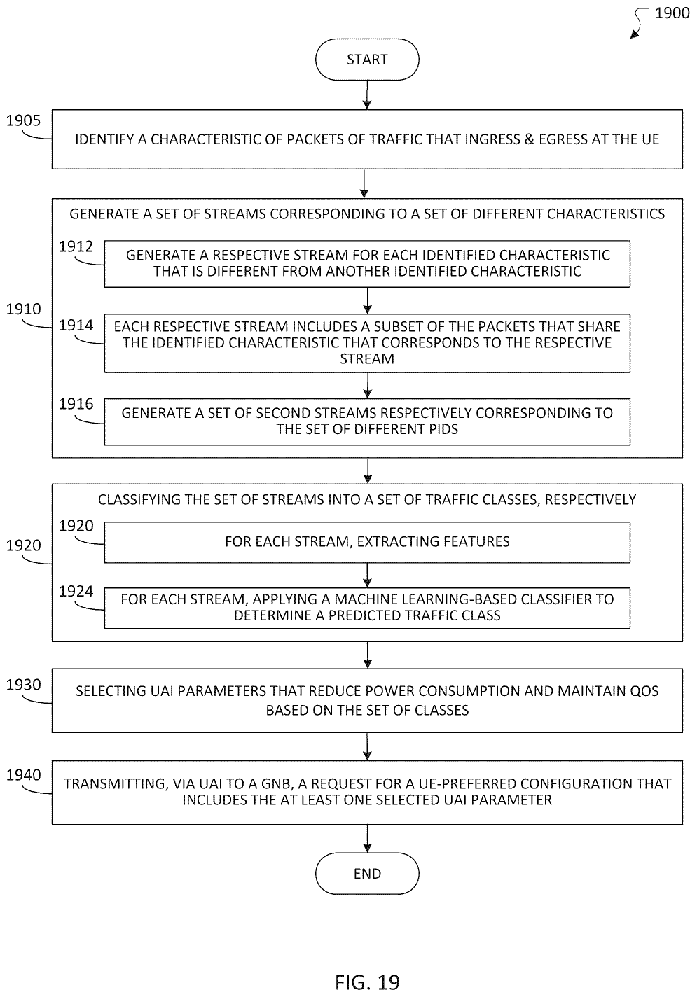

FIG. 19 illustrates a method 1900 for AI-based network mixed-service detection for UE power saving, in accordance with an embodiment of this disclosure. The embodiment of the method 1900 shown in FIG. 19 is for illustration only, and other embodiments could be used without departing from the scope of this disclosure. The method 1900 is implemented by an electronic device, such as the UE 116 of FIG. 3. More particularly, the method 1900 could be performed by a processor 340 of the electronic device.

The method 1900 starts by monitoring one or more packets of traffic that ingress and egress at the UE. For example, the packet 502 of FIG. 5 is monitored.

In block 1905, the processor 340 identifies a characteristic of the packets of traffic that ingress and egress at the UE 116. As characteristic of each respective packet 502, the processor 340 can identify a process identifier (PID) that uniquely identifies a mobile application 362 that generated the respective packet 502. In some embodiments, the identified characteristic of each respective packet 502 is a TCP/IP five-tuple socket extracted from a packet header of the respective packet.

At block 1910, the processor 340 generates a set of streams corresponding to a set of different characteristics. For example, the set of streams 515 is generated and includes streams 515a through 515c of FIG. 5.

At block 1912, to generate the set of streams, the processor 340 generates a respective stream corresponding each identified characteristic that is different from another identified characteristic. For example, a first stream 615_1 can include packets having a socket, which is defined by the TCP protocol with ports (A₁, B₁, X₁, and Y₁) as the identified characteristic. A second stream 615_M can include packets having a different socket, which is defied by the UDP protocol with ports (Aₘ, Bₘ, Xₘ, and Yₘ) as the identified characteristic, as shown in FIG. 6. As another example, a first stream 1215_1 can include packets having PID A as the identified characteristic, while a second stream 1215_2 can include packets having PID M as the identified characteristic, as shown in FIG. 12.

At block 1914, to generate the set of streams, each respective stream includes a subset of the packets that share the identified characteristic that corresponds to the respective stream. When the PID is identified as the characteristic of a packet, then the set of streams correspond to a set of different PIDs that respectively identify a set of mobile applications currently executing on the UE, and each respective stream includes a subset of the packets that share a same PID and that are generated by a same mobile application.

In some embodiments, when the TCP/IP five-tuple socket is identified as the characteristic of a packet, then the set of streams correspond to a set of different sockets, and each respective stream includes a subset of the packets that share the same socket. The processor 340 can further identify the PID as a second characteristic of the packets of traffic that ingress and egress at the UE. As shown at block 1916, the processor 340 can generate a set of second streams respectively corresponding to the set of different PIDs, wherein each respective second stream includes a subset of the streams that share the identified PID that corresponds to the respective stream. In this example, the per-flow streams 1217 form a first set of streams, and the per-PID streams 1215 form a second set of streams, as shown in FIG. 12.

At block 1920, the processor 340 classifies the set of streams 515 into a set of traffic classes, respectively, based on features 535 extracted from the set of streams 515 every sampling window tₛₐₘₚₗₑ. For example, in FIG. 5, streams 515a, 515b, 515-c are classified as the set {c_{stream,A}, c_{stream,B}, c_{stream,C}} output from the post-processing module 550, which can be {video streaming, audio call, and background traffic} as an example corresponding to the set of traffic classes in rows {1, 4, 6}. At block 1922, to classify the set of streams, the processor computes the features per stream based on packets in the respective stream, thereby extracting the features. At block 1924, the processor 340 applies an ML-based classifier to a respective stream to determine a predicted traffic class for the respective stream.

At block 1930, the processor 340 selects, from a set of UAI parameters that impact UE power consumption and QoS, at least one UAI parameter to reduce power consumption of the UE while maintaining a QoS level based on the set of traffic classes. For example, the UAI parameters 1326 can be selected from among the pool of candidate parameters 1324, as shown in FIG. 13. For example, the method 1400 of FIG. 14 can be applied to maintain the QoS.

In some embodiments of block 1930, the processor 340 selects the at least one UAI parameter to meet the QoS level defined by: a selected bandwidth, a selected number of multiple-input multiple-output (MIMO) layers, and a selected discontinuous reception (CDRX) parameters. The processor 340 monitors a throughput capacity and a demand of data rate. The processor increases a bandwidth by a tunable frequency step-size (δ₁) or incrementing a number of MIMO layers, based on a determination that a throughput experienced at the UE exceeds a tunable margin (β) of link capacity.

At block 1940, the processor 340 controls the UE 116 to transmit, via UAI to a gNB 102, a request for a UE-preferred configuration that includes the at least one selected UAI parameter 1326.

Although FIG. 19 illustrates an example method 1900 for AI-based network mixed-service detection for UE power saving, various changes may be made to FIG. 19. For example, while shown as a series of steps, various steps in FIG. 19 could overlap, occur in parallel, occur in a different order, or occur any number of times. As a particular example, after the set of streams are respectively classified into the set of traffic classes, the processor 340 determines a per-PID traffic class for each among the set of second streams based on a weighted majority vote 1212, as shown in FIG. 12. The weighted majority vote includes a per-stream traffic class from each stream among the subset of the streams that share the corresponding PID. The processor 340 selects the at least one UAI parameter based on the per-PID traffic classes corresponding to the set of second streams.

As another example of the method 1900, when the PID is identified as the characteristic of a packet, then the set of streams correspond to a set of different PIDs that respectively identify a set of mobile applications currently executing on the UE, and each respective stream includes a subset of the packets that share a same PID and that are generated by a same mobile application. To generate the set of first streams, the processor 340 maps the PID corresponding to the respective stream to cross-reference with the socket extracted from the packet header of each respective packet among the packets of traffic that ingress and egress at the UE. The flow-PID mapping 1803 is an example shown in FIG. 18. The processor 340 aggregates, into the respective stream 1815_A, each respective packet 1802 of traffic that ingresses at the UE via a first socket cross-referenced to the PID (such as PID A) corresponding to the respective stream. Each respective packet 1802 of traffic that egresses at the UE via a second socket cross-referenced to the PID (such as PID A) corresponding to the respective stream 1815_A.

In some embodiments of block 1910, to generate the set of streams, the processor 340 performs mapping. For example, mapping the set of traffic classes to a set of application service groups, respectively. Each application service group includes one or more application service types from a set of different application service types. Each application service group, the one or more application service types share a throughput requirement and a latency requirement. For each respective stream among the set of streams: the processor 340 determines which application service type is consumed by the subset of packets within the respective stream, from among the set of different application service types, based on features that are extracted from the respective stream and processed through a machine-learning based (ML-based) classifier that is trained to generate a prediction that indicates the consumed application service type; classifies the respective stream into the traffic class mapped to the application service group that includes the consumed application service type; and records the prediction generated by the ML-based classifier for a current sampling window into a queue for the respective stream, thereby commencing capture of a historical traffic pattern in which a number (m) of predictions generated by the ML-based classifier for the current sampling window and m−1 previous sampling windows are concatenated. The sliding window 700 of FIG. 7 is an example of the historical traffic pattern recorded.

In some embodiments of the method 1900, to determine the consumed application service type that is consumed by the subset of packets within the respective stream, the processor 340 can determine the respective stream is inactive and not operating and not operating the ML-based classifier of the inactive stream, in response to a determination that no packets of traffic ingress and egress at the respective stream for a specified period (t_{active,2}). The processor 340 selects, as the consumed application service type: a previous prediction generated by the ML-based classifier for a previous sampling window, based on the determination that the respective stream is inactive; or the prediction generated by the ML-based classifier for a current sampling window or, based on a determination that the respective stream is active.

In some embodiments of the method 1900, the processor can pause operation of the ML-based classifier while the captured historical traffic pattern indicates the consumed application service type consecutively with a number (Nₛₜᵣₑₐₘ_{ₛₜₒₚ}) of confidence levels respectively greater than or equal to a threshold confidence (pₛₜₒₚ). The processor 340 detects a change of which application service type is consumed by the subset of packets within the respective stream, while the ML-based classifier is paused.

In some embodiments of block 1920, the processor 340 classifies new streams detected. For every sampling window, the processor 340 determines whether the set of streams includes a new stream. The processor 340 classifies each new stream among the set of streams as one from among a set of different application service types, based on the features extracted from an initial sampling window of the new stream. In response to a determination that a respective stream among the set of streams is not a new stream, the processor 340 maintains an initial classification Cone-shot from a previous sampling window of the respective stream and detects a change of application service type consumed by the subset of packets within the respective stream.

For each new stream among the set of streams, the processor 340: computes the features extracted from the initial sampling window of the new stream; and processes the computed features through a multilayer perceptron (MLP) to generate a statistical embedding vector. For an initial number of packets among the subset of the packets in the new stream each new stream among the set of streams, the processor 340 transforms a packet header into a two-dimensional binary matrix. The processor 340 processes the transformed packet header through a convolutional neural network, a flattening algorithm, and a fully connected layer to generate the header bitmap embedding vector. The processor 340 concatenates and processes both, the statistical embedding vector and the head bitmap embedding vector, through a fusion MLP to generate a final predicted traffic class label.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a user equipment (UE), the method comprising:
identifying a characteristic of packets of traffic at the UE;
generating a set of streams corresponding to a set of different characteristics, wherein generating the set of streams comprises:
generating a respective stream corresponding each identified characteristic that is different from another identified characteristic, wherein each respective stream includes a subset of the packets that share the identified characteristic that corresponds to the respective stream;
classifying the set of streams into a set of traffic classes, respectively, based on features extracted from the set of streams every sampling window;
selecting, from a set of UE assistance information (UAI) parameters that impact UE power consumption and quality of service (QOS), at least one UAI parameter to reduce power consumption of the UE while maintaining a QoS level based on the set of traffic classes; and
transmitting, via UAI to a gNB, a request for a UE-preferred configuration that includes the at least one selected UAI parameter.

2. The method of claim 1, wherein identifying the characteristic of the packets of traffic further comprises identifying, as the characteristic of each respective packet, one from among:
a process identifier (PID) that uniquely identifies a mobile application that generated the respective packet, wherein the set of streams correspond to a set of different PIDs that respectively identify a set of mobile applications currently executing on the UE, and wherein each respective stream includes a subset of the packets that share a same PID and that are generated by a same mobile application; and
a transmission control protocol/internet protocol (TCP/IP) five-tuple socket extracted from a packet header of the respective packet, wherein the set of streams correspond to a set of different sockets, wherein each respective stream includes a subset of the packets that share the same socket.

3. The method of claim 2, further comprising:
identifying the socket as the characteristic of the packets of traffic;
generating the set of streams corresponding to the set of the different sockets;
identifying the PID as a second characteristic of the packets of traffic that ingress and egress at the UE;
generating a set of second streams respectively corresponding to the set of different PIDs, wherein each respective second stream includes a subset of the streams that share the identified PID that corresponds to the respective stream;
after the set of streams are respectively classified into the set of traffic classes, determining a per-PID traffic class for each among the set of second streams based on a weighted majority vote,
wherein the weighted majority vote includes a per-stream traffic class from each stream among the subset of the streams that share the corresponding PID; and
selecting the at least one UAI parameter based on the per-PID traffic classes corresponding to the set of second streams.

4. The method of claim 2, wherein:
identifying the characteristic of the packets of traffic further comprises identifying the PID as the characteristic of each respective packet among the packets of traffic that ingress and egress at the UE; and
generating the respective stream corresponding each identified characteristic that is different from another identified characteristic further comprises:
mapping the PID corresponding to the respective stream to cross-reference with the socket extracted from the packet header of each respective packet among the packets of traffic that ingress and egress at the UE; and
aggregating, into the respective stream, each respective packet of traffic that ingresses at the UE via a first socket cross-referenced to the PID corresponding to the respective stream, and each respective packet of traffic that egresses at the UE via a second socket cross-referenced to the PID corresponding to the respective stream.

5. The method of claim 1, further comprising:
mapping the set of traffic classes to a set of application service groups, respectively, wherein:
each application service group includes one or more application service types from a set of different application service types; and
within each application service group, the one or more application service types share a throughput requirement and a latency requirement; and
for each respective stream among the set of streams:
determining which application service type is consumed by the subset of packets within the respective stream, from among the set of different application service types, based on features that are extracted from the respective stream and processed through a machine-learning based (ML-based) classifier that is trained to generate a prediction that indicates the consumed application service type;
classifying the respective stream into the traffic class mapped to the application service group that includes the consumed application service type; and
recording the prediction generated by the ML-based classifier for a current sampling window into a queue for the respective stream, thereby commencing capture of a historical traffic pattern in which a number (m) of predictions generated by the ML-based classifier for the current sampling window and m−1 previous sampling windows are concatenated.

6. The method of claim 5, wherein determining the consumed application service type that is consumed by the subset of packets within the respective stream comprises:
determining the respective stream is inactive and not operating and not operating the ML-based classifier of the inactive stream, in response to a determination that no packets of traffic ingress and egress at the respective stream for a specified period; and
selecting, as the consumed application service type,
a previous prediction generated by the ML-based classifier for a previous sampling window, based on the determination that the respective stream is inactive; or
the prediction generated by the ML-based classifier for a current sampling window or, based on a determination that the respective stream is active.

7. The method of claim 5, further comprising:
pausing operation of the ML-based classifier while the captured historical traffic pattern indicates the consumed application service type consecutively with a number of confidence levels respectively greater than or equal to a threshold confidence; and
detecting a change of which application service type is consumed by the subset of packets within the respective stream, while the ML-based classifier is paused.

8. The method of claim 1, further comprising:
selecting the at least one UAI parameter to meet the QoS level defined by: a selected bandwidth, a selected number of multiple-input multiple-output (MIMO) layers, and a selected discontinuous reception (CDRX) parameters;
monitoring a throughput capacity and a demand of data rate; and
increasing a bandwidth by a tunable frequency step-size or incrementing a number of MIMO layers, based on a determination that a throughput experienced at the UE exceeds a tunable margin of link capacity.

9. The method of claim 1, further comprising:
for every sampling window, determining whether the set of streams includes a new stream;
classifying each new stream among the set of streams as one from among a set of different application service types, based on the features extracted from an initial sampling window of the new stream; and
in response to a determination that a respective stream among the set of streams is not a new stream, maintaining an initial classification from a previous sampling window of the respective stream and detecting a change of application service type consumed by the subset of packets within the respective stream.

10. The method of claim 9, further comprising for each new stream among the set of streams:
computing the features extracted from the initial sampling window of the new stream;
processing the computed features through a multilayer perceptron (MLP) to generate a statistical embedding vector;
for an initial number of packets among the subset of the packets in the new stream, transforming a packet header into a two-dimensional binary matrix;
processing the transformed packet header through a convolutional neural network, a flattening algorithm, and a fully connected layer to generate a header bitmap embedding vector; and
concatenating and processing both, the statistical embedding vector and the header bitmap embedding vector, through a fusion MLP to generate a final predicted traffic class label.

11. A user equipment (UE) comprising:
a processor configured to:
identify a characteristic of packets of traffic at the UE;
generate a set of streams corresponding to a set of different characteristics, wherein generating the set of streams comprises:
generating a respective stream corresponding each identified characteristic that is different from another identified characteristic, wherein each respective stream includes a subset of the packets that share the identified characteristic that corresponds to the respective stream;
classify the set of streams into a set of traffic classes, respectively, based on features extracted from the set of streams every sampling window; and
select, from a set of UE assistance information (UAI) parameters that impact UE power consumption and quality of service (QOS), at least one UAI parameter to reduce power consumption of the UE while maintaining a QoS level based on the set of traffic classes; and
a transceiver operably coupled with the processor, the transceiver configured to transmit, via UAI to a gNB, a request for a UE-preferred configuration that includes the at least one selected UAI parameter.

12. The UE of claim 11, wherein to identify the characteristic of the packets of traffic the processor is further configured to identify, as the characteristic of each respective packet, one from among:
a process identifier (PID) that uniquely identifies a mobile application that generated the respective packet, wherein the set of streams correspond to a set of different PIDs that respectively identify a set of mobile applications currently executing on the UE, and wherein each respective stream includes a subset of the packets that share a same PID and that are generated by a same mobile application; and
a transmission control protocol/internet protocol (TCP/IP) five-tuple socket extracted from a packet header of the respective packet, wherein the set of streams correspond to a set of different sockets, wherein each respective stream includes a subset of the packets that share the same socket.

13. The UE of claim 12, wherein the processor is further configured to:
identify the socket as the characteristic of the packets of traffic;
generate the set of streams corresponding to the set of the different sockets;
identify the PID as a second characteristic of the packets of traffic that ingress and egress at the UE;
generate a set of second streams respectively corresponding to the set of different PIDs, wherein each respective second stream includes a subset of the streams that share the identified PID that corresponds to the respective stream;
after the set of streams are respectively classified into the set of traffic classes, determine a per-PID traffic class for each among the set of second streams based on a weighted majority vote,
wherein the weighted majority vote includes a per-stream traffic class from each stream among the subset of the streams that share the corresponding PID; and
select the at least one UAI parameter based on the per-PID traffic classes corresponding to the set of second streams.

14. The UE of claim 12, wherein:
to identify the characteristic of the packets of traffic, the processor is further configured to identify the PID as the characteristic of each respective packet among the packets of traffic that ingress and egress at the UE; and
to generate the respective stream corresponding each identified characteristic that is different from another identified characteristic, the processor is further configured to:
map the PID corresponding to the respective stream to cross-reference with the socket extracted from the packet header of each respective packet among the packets of traffic that ingress and egress at the UE; and
aggregate, into the respective stream, each respective packet of traffic that ingresses at the UE via a first socket cross-referenced to the PID corresponding to the respective stream, and each respective packet of traffic that egresses at the UE via a second socket cross-referenced to the PID corresponding to the respective stream.

15. The UE of claim 11, wherein the processor is further configured to:
map the set of traffic classes to a set of application service groups, respectively, wherein:
each application service group includes one or more application service types from a set of different application service types; and
within each application service group, the one or more application service types share a throughput requirement and a latency requirement; and
for each respective stream among the set of streams, the processor is further configured to:
determine which application service type is consumed by the subset of packets within the respective stream, from among the set of different application service types, based on features that are extracted from the respective stream and processed through a machine-learning based (ML-based) classifier that is trained to generate a prediction that indicates the consumed application service type;
classify the respective stream into the traffic class mapped to the application service group that includes the consumed application service type; and
record the prediction generated by the ML-based classifier for a current sampling window into a queue for the respective stream, thereby commencing capture of a historical traffic pattern in which a number (m) of predictions generated by the ML-based classifier for the current sampling window and m−1 previous sampling windows are concatenated.

16. The UE of claim 15, wherein to determine the consumed application service type that is consumed by the subset of packets within the respective stream, the processor is further configured to:
determine the respective stream is inactive and not operating and not operating the ML-based classifier of the inactive stream, in response to a determination that no packets of traffic ingress and egress at the respective stream for a specified period; and
select, as the consumed application service type,
a previous prediction generated by the ML-based classifier for a previous sampling window, based on the determination that the respective stream is inactive; or
the prediction generated by the ML-based classifier for a current sampling window or, based on a determination that the respective stream is active.

17. The UE of claim 15, wherein the processor is further configured to:
pause operation of the ML-based classifier while the captured historical traffic pattern indicates the consumed application service type consecutively with a number of confidence levels respectively greater than or equal to a threshold confidence; and
detect a change of which application service type is consumed by the subset of packets within the respective stream, while the ML-based classifier is paused.

18. The UE of claim 11, wherein the processor is further configured to:
select the at least one UAI parameter to meet the QoS level defined by: a selected bandwidth, a selected number of multiple-input multiple-output (MIMO) layers, and a selected discontinuous reception (CDRX) parameters;
monitor a throughput capacity and a demand of data rate; and
increase a bandwidth by a tunable frequency step-size or incrementing a number of MIMO layers, based on a determination that a throughput experienced at the UE exceeds a tunable margin of link capacity.

19. The UE of claim 11, wherein the processor is further configured to:
for every sampling window, determine whether the set of streams includes a new stream;
classifying each new stream among the set of streams as one from among a set of different application service types, based on the features extracted from an initial sampling window of the new stream; and
in response to a determination that a respective stream among the set of streams is not a new stream, maintain an initial classification from a previous sampling window of the respective stream and detecting a change of application service type consumed by the subset of packets within the respective stream.

20. The UE of claim 19, wherein the processor is further configured to, for each new stream among the set of streams:
compute the features extracted from the initial sampling window of the new stream;
process the computed features through a multilayer perceptron (MLP) to generate a statistical embedding vector;
for an initial number of packets among the subset of the packets in the new stream, transform a packet header into a two-dimensional binary matrix;
process the transformed packet header through a convolutional neural network, a flattening algorithm, and a fully connected layer to generate a header bitmap embedding vector; and
concatenate and processing both, the statistical embedding vector and the header bitmap embedding vector, through a fusion MLP to generate a final predicted traffic class label.
